(19) United States
(12) Patent Application Publication
(10) Pub. No.: US 2011/0014378 A1
(43) Pub. Date: Jan. 20, 2011

(54) LEVELING DEVICES AND METHODS

(75) Inventors: John Edward BUSSAN, Naperville, IL (US); Sergey V. Rozhok, Skokie, IL (US); Vadim Val-Khvalabov, Chicago, IL (US); Joseph S. Fragala, San Jose, CA (US); Jason R. Haaheim, Chicago, IL (US); Michael R. Nelson, Libertyville, IL (US); Edward R. Solheim, Mount Prospect, IL (US); Javad M. Vakil, Morton Grove, IL (US)

Correspondence Address: FOLEY AND LARDNER LLP;SUITE 500, 3000 K STREET NW, WASHINGTON, DC, 20007, US

(73) Assignee: NanoInk, Inc.

(21) Appl. No.: 12/838,384

(22) Filed: Jul. 16, 2010

Related U.S. Application Data
(60) Provisional application No. 61/226,579, filed on Jul. 17, 2009.

(51) Int. Cl. B05D 3/12; G01Q 70/02; G01Q 70/00; G01Q 80/00; G01Q 20/02; F16M 13/00

(52) U.S. Cl. 427/275; 850/53; 850/52; 850/62; 850/6; 248/288.11; 248/288.31; 248/281.11

(57) ABSTRACT

Devices for leveling an object for patterning a substrate surface, including an array of scanning probe tips, are provided. A device may include a support structure adapted to mount an object, the object having a plurality of protrusions adapted to form a pattern on a surface of a substrate upon contact of the object to the surface; and at least one flexible joint assembly mounted to the support structure and adapted to allow the object to achieve a parallel orientation with respect to the surface upon contact of the object to the surface. Also provided are apparatuses and kits incorporating the devices and methods of making and using the devices and apparatuses.

### RELATED APPLICATIONS

This application claims priority to U.S. provisional application Ser. No. 61/226,579 filed Jul. 17, 2009, which is hereby incorporated by reference in its entirety.

### BACKGROUND

Small scale manufacturing is an important aspect of the modem economy. For example, methods such as microcontact printing, nanoimprint lithography, and Dip-Pen Nanolithography® (DPN®) printing can be used to make microscale and nanoscale structures and patterns. For microcontact printing and nanoimprint lithography, see, e.g., C. M. Sotomayor Tones, Alternative Lithography: Unleashing the Potentials of Nanotechnology (Nanostructure Science and Technology), 2003. See also, for example, U.S. Pat. Nos. 6,380,101; 6,518,189; 6,818,959; 7,442,316; and 7,665,983. For DPN® printing, see, e.g., U.S. Pat. Nos. 6,635,311 to Mirkin et al. and 6,827,979 to Mirkin et al. Direct write methods, including DPN® printing, are useful as a pattern can be directly drawn or embedded into a substrate surface. In one embodiment of DPN®, material is transferred from a tip (or an array of tips) to a substrate using, for example, one or more nanoscopic, scanning probe, or atomic force microscope tips. DPN® can be used with multiple tips, including one- and two-dimensional arrays of tips, operating in parallel on a single instrument. See, e.g., U.S. Pat. Pub. No. 2008/0105042 to Mirkin et al. In all of the small scale manufacturing methods described above, patterning can be carried out to make a variety of structures on substrate surfaces including soft and hard structures, organic and inorganic structures, and biological structures, in a variety of regular or irregular patterns.

Despite important advances, a need exists to provide devices and patterning apparatuses which provide higher quality patterns and ease of use. For example, poor patterning can result if stamps (in the case of microcontact printing), molds (in the case of nanoimprint lithography), or tips (in the case of DPN) are not aligned in a parallel orientation with respect to the surface of the substrate to be patterned. However, leveling and alignment of large numbers of stamp/mold protrusions or tips is an engineering challenge. Other challenges include viewing of the stamp, mold, or tips during the leveling process, providing user feedback that indicates that leveling has been achieved, and maintaining a parallel orientation during patterning and/or after patterning, i.e., after contact with the surface has been broken.

### SUMMARY

Provided herein are devices for leveling, apparatuses incorporating such devices, kits, methods of using and making the devices.

One embodiment provides a device comprising a support structure adapted to mount an object, the object comprising a plurality of protrusions adapted to form a pattern on a surface of a substrate upon contact of the object to the surface; and at least one flexible joint assembly mounted to the support structure and adapted to allow the object to achieve a parallel orientation with respect to the surface upon contact of the object to the surface.

Another embodiment provides a device comprising a support structure adapted to mount an array of nanoscopic tips, the array adapted to form a pattern on a surface of a substrate upon contact of the array to the surface; and at least one magnetic flexible joint assembly mounted to the support structure comprising a ball, and a magnetic joint member, the joint member comprising a depression shaped to accommodate the ball, wherein the magnetic flexible joint assembly is adapted to allow the array to achieve a parallel orientation with respect to the surface upon contact of the object to the surface.

Another embodiment provides a device comprising a support structure adapted to mount an object, the object comprising a plurality of protrusions adapted to form a pattern on a surface of a substrate upon contact of the object to the surface; and a plurality of flexible joint assemblies mounted to the support structure, the plurality of joint assemblies comprising a first flexible joint assembly positioned along a first axis parallel to the support structure, a second flexible joint assembly positioned along the first axis and opposite to the first flexible joint assembly, a third flexible joint assembly positioned along a second axis parallel to the support structure and perpendicular to the first axis, and a fourth flexible joint assembly positioned along the second axis and opposite to the third flexible joint assembly; wherein the plurality of flexible joint assemblies is adapted to allow the object to achieve a parallel orientation with respect to the surface upon contact of the object to the surface.

Another embodiment provides a device comprising: a support structure adapted to mount an array of nanoscopic tips, the array adapted to form a pattern on a surface of a substrate upon contact of the array to the surface; a first magnetic flexible joint assembly mounted to the support structure and positioned along a first axis parallel to the support structure; a second magnetic flexible joint assembly mounted to the support structure and positioned along the first axis and opposite to the first magnetic flexible joint assembly; a middle structure positioned above the support structure and mounted to the first magnetic flexible joint assembly and the second magnetic flexible joint assembly; a third magnetic flexible joint assembly mounted to the middle structure and positioned along a second axis parallel to the support structure and perpendicular to the first axis; a fourth magnetic flexible joint assembly mounted to the middle structure and positioned along the second axis and opposite to the third magnetic flexible joint assembly; and an upper structure positioned above the middle structure and mounted to the third magnetic flexible joint assembly and the fourth magnetic flexible joint assembly, wherein each magnetic flexible joint assembly comprises: a ball; and a joint member, the joint member comprising a depression shaped to accommodate the ball, wherein the ball or the joint member is magnetic, and further wherein the magnetic flexible joint assemblies are adapted to allow the array to achieve a parallel orientation with respect to the surface upon contact of the array to the surface.

Another embodiment provides an apparatus comprising a patterning instrument and a device, wherein the device is mounted to the patterning instrument, and further wherein the device comprises a support structure adapted to mount an object, the object comprising a plurality of protrusions adapted to form a pattern on a surface of a substrate upon contact of the object to the surface, and at least one flexible joint assembly mounted to the support structure and adapted to allow the object to achieve a parallel orientation with respect to the surface upon contact of the object to the surface.

Another embodiment provides a method comprising providing a device comprising a support structure adapted to mount an object, the object comprising a plurality of protrusions adapted to form a pattern on a surface of a substrate upon contact of the object to the surface, and at least one flexible joint assembly mounted to the support structure and adapted to allow the object to achieve a parallel orientation with respect to the surface upon contact of the object to the surface; mounting the object to the support structure; contacting the mounted object to the substrate; and allowing the object to achieve a parallel orientation with respect to the surface.

Another embodiment provides a method comprising providing a device comprising a support structure adapted to mount an object, the object comprising a plurality of protrusions adapted to form a pattern on a surface of a substrate upon contact of the object to the surface; and at least one flexible joint assembly mounted to the support structure and adapted to allow the object to achieve a parallel orientation with respect to the surface upon contact of the object to the surface; mounting the object to the support structure; providing at least some of the protrusions with an ink composition; and transferring the ink composition from the protrusions to the surface.

Another embodiment provides a mounting fixture adapted to facilitate the mounting of an object to a support structure, the object comprising a plurality of protrusions adapted to form a pattern on a surface of a substrate upon contact of the object to the surface.

Another embodiment provides a method including contacting a plurality of protrusions to a substrate surface, wherein the plurality of protrusions are disposed over a plurality of cantilevers; deflecting the plurality of cantilevers; observing an optical change indicative of surface contact between the plurality of protrusions and the substrate surface; and further leveling the plurality of protrusions using at least one flexible joint assembly mounted to a support structure.

At least one advantage for at least one embodiment is the ability to level an object for patterning a substrate surface, including an object having a large number of patterning protrusions, with minimal effort and in minimal time.

At least one advantage for at least one embodiment is the ability to achieve better patterning results with a leveled object for patterning a substrate surface.

At least one advantage for at least one embodiment is the ability to view an object for patterning a substrate surface during the leveling process.

At least one advantage for at least one embodiment is the ability to provide feedback that leveling has been achieved.

At least one advantage for at least one embodiment is the ability to maintain the level orientation of an object for patterning a substrate surface after contact with the surface is broken.

At least one additional advantage for at least one embodiment, due to the self-leveling aspect of the device, is that the some of process, or the entire process, can be automated, since there is reduced need for human measurement/interference. Reducing the impact of the human-element of error and subjectivity can lead to a more accurate and precise leveling process. Because the process can be automated, throughput, ease of use, and overall speed of operation can be dramatically improved.

### BRIEF DESCRIPTION OF THE DRAWINGS

The Figures provide exemplary embodiments.

FIG. 1 is an exemplary embodiment of a device for leveling including a support structure adapted for mounting an object for patterning a substrate surface and a flexible joint assembly mounted to the support structure.

FIG. 2A is a side view of an exemplary embodiment of a device for leveling including a support structure adapted for mounting an object for patterning a substrate surface, a flexible joint assembly mounted to the support structure, a mounting structure mounted to the flexible joint assembly, and a signaling system coupled to the device. FIG. 2B is a top view of the device shown in FIG. 2A.

FIG. 3 is a view of a disassembled, exemplary embodiment of a device for leveling including a support structure adapted for mounting an object for patterning a substrate surface, a first pair of flexible joint assemblies, a middle structure mounted to the first pair of flexible joint assemblies, a second pair of flexible joint assemblies, and an upper structure mounted to the second pair of flexible joint assemblies.

FIG. 4A is a top, perspective view of the assembled device shown in FIG. 3. FIG. 4B is a bottom, perspective view of the assembled device shown in FIG. 3. FIG. 4C is a picture of the device assembled, mounted, and in use.

FIG. 5 is a view of an assembled, exemplary embodiment of a device for leveling including a support structure adapted for mounting an object for patterning a substrate surface, a plurality of flexible joint assemblies mounted to the support structure, a middle structure and an upper structure mounted to the plurality of flexible joint assemblies, and a mounting structure mounted to the upper structure.

FIG. 6 is an exemplary embodiment of a mounting fixture adapted to facilitate the mounting of an object to a support structure.

FIG. 7A is a schematic of multiplexed 2D-DPN.

FIG. 7B is an idealized schematic of a rapid prototyping platform for multiplexed protein printing.

FIG. 8A is a top view of the 2D nano PrintArray mounted to the self-leveling handle.

FIG. 8B is a bottom view of the 2D nano PrintArray.

FIG. 8C is an optical microscope image of the tips and cantilevers showing their arrangement and pitch, and the placement and size of the viewports.

FIG. 8D is an SEM image of the tips and cantilevers showing the underlying structure that permits their freedom of travel.

FIG. 8E is a zoomed SEM image of the cantilevers in front of a viewport.

FIG. 8F is an SEM image of the cantilever's freedom of travel.

FIG. 9A is a schematic of 2D nano PrintArray just before making contact with the minimum allowable planarity to get all of the tips touching.

FIG. 9B illustrates that all of the tips are in contact, but the standoff on the right side of the device is also touching the substrate; φ needs to be minimized to achieve the best planarity and subsequent patterning homogeneity.

FIG. 10A is an optical image of the 2D nano PrintArray cantilevers as seen through a viewport. The tips are hovering 1 μm above the substrate, just before making contact. The red-orange refracted light “butterfly wing” formation inside the pyramidal tip has not yet undergone the change indicative of substrate contact.

FIG. 10B illustrates that the cantilevers are fully deflected, indicating that the corner standoffs are uniformly touching. The “butterfly wings” have commensurately changed shape, color, and intensity.

FIG. 11A illustrates an NLP 2000 software interface showing the point-of-contact measurements made at viewports 1b, 2b, and 3b immediately after coarse-self-leveling. Upon using the “Execute Leveling” command, the system adjusts the φₓ-φ_{y} stages to compensate for the planar misalignment.

FIG. 11B illustrates the point-of-contact measurements immediately re-measured after the compensation. The slope of 0.002° and ΔZ=600 nm correspond to the cantilever deflection detection limit of ±100 nm, which means that the device was as planar as could be measured with these methods.

FIGS. 12A-12D are dark field microscopy images from the homogeneous cm²-area pattern generated from the FIG. 11 printing conditions. The dots are 3-μm pitch with 2-s dwell time, and are 15-nm thick gold structures on a SiO₂ substrate.

FIG. 12E illustrates the NLP 2000 software-generated pattern design.

FIG. 13A shows tiled bright field microscopy images illustrating pattern homogeneity across the entire square centimeter, with feature size standard deviation <6%.

FIG. 13B shows a zoomed area showing the “DPN DPN” result uniformity.

FIG. 13C shows the pattern from the software design.

FIG. 14 includes two sets of self-leveling-fixture stability data show both that the absolute Z-positions of the viewports remain constant and that their relationship to each other remains fixed during self-leveling operations. This confirms that the strength of the magnets maintains the device's planar orientation after self-leveling. (A) Device #1 has a unique angular resolution as shown by the viewport spread. This is because of the unique material interface between the spherical magnetic ball and its kinematic mount. (B) A slightly different angular resolution and material interface is seen for device #2, but both are well within reasonable working limits.

FIGS. 15A-C are perspective views of an apparatus and an object during the self-leveling process.

FIGS. 16A-C are perspective views of an apparatus and an object during the self-leveling process.

FIGS. 17A-C show a process of determining the first contact point by examining the “butterfly wing” light diffraction behavior from the protrusions (pyramids).

### DETAILED DESCRIPTION

### Introduction

All references cited in the present application are incorporated by reference in their entirety.

Priority U.S. provisional application Ser. No. 61/226,579 filed Jul. 17, 2009 is hereby incorporated by reference in its entirety. The article Haaheim et al., “Self-Leveling Two-Dimensional Probe Arrays for Dip Pen Nanolithography,” Scanning, 32, 49-59 (2010) is also hereby incorporated by reference in its entirety.

The term “mount” can include, for example, join, unite, connect, associate, insert, hang, hold, affix, attach, fasten, bind, paste, secure, bolt, screw, rivet, solder, weld, press against, and other like terms. Moreover, “mount” can encompass objects that are directly mounted together and objects that are indirectly mounted to one another, e.g., through a separate component.

Herein, a self-leveling fixture for printing devices, such as the 2D nano PrintArray for example, is described and demonstrated. When mounted on, for example, NanoInk's NLP 2000 instrument for nanopatterning, for example, a 55,000 tip array can achieve a planarity of, for example, less than 0.1° with respect to a substrate in a matter of seconds, with little or no user manipulation required. Additional fine-leveling routines can improve this planarity to, for example, less than 0.002° with respect to the substrate—a Z-difference of, for example, less than 600 nm across 1 cm² of surface area. A highly homogeneous etch-resist nanostructure can be made from a self-leveled array of tips, e.g., DPN pens.

The self-leveling process, it is believed, can be generally faster, easier, and more precise than previous methods. This brings the process towards automated nanomanufacturing. The planar misalignment can be less than, for example, 0.002° in accordance with the representative embodiments, which is believed to be better than previous results. The excellent planarity correlates to uniform patterning results, resulting in homogeneous nanostructures across 1 cm². This is also believed to be better than previous results, which were quantified by a feature size standard deviation of 6% which is believed the best previously reported.

In the representative embodiments disclosed herein, the self-leveling gimbal device can achieve homogeneous results through (1) precise Z-positioning through accurate touch-down detection; and (2) low variance in cantilever deflection through very precise leveling.

A device for leveling can include a support structure and at least one flexible joint assembly mounted to the support structure.

### Support Structure

Support structures can be adapted to mount an object having a plurality of protrusions for forming a pattern on a substrate. Support structures can be further adapted to be mounted to an apparatus for disposing an ink composition on the plurality of protrusions. Support structures can include one or more apertures for viewing an object mounted to the support structure. The shape and dimensions of the support structures may vary. Non-limiting examples of support structures are described below and illustrated in the figures. Similarly, the materials used to form the support structures may vary. In fact, any rigid material may be used. Suitable materials include, but are not limited to, stainless steel, aluminum, plastics, and ceramics.

The support structure and the object can be mounted together so that they function as a single piece, moving in space as one piece or an integral unit. The mount can be a rigid mount rather than a flexible mount.

### Flexible Joint Assemblies

Flexible joint assemblies can be adapted to allow an object mounted to the support structure to achieve a parallel orientation with respect to a surface upon contact of the object to the surface. By “flexible joint assembly,” it is meant an assembly of components which form a joint that is capable of flexing in one or more directions. By way of example only, flexible joint assemblies include rotary joint assemblies or pivot joint assemblies. Such flexible joint assemblies are capable of flexing in multiple directions via a rotating motion. The flexible joint assemblies may be further adapted to allow an object mounted to the support structure to maintain a parallel orientation with respect to a surface after contact with the surface is broken.

The ability of the flexible joint assemblies to allow objects mounted thereon to achieve and maintain a parallel orientation with respect to a surface is affected, at least in part, by the coefficient of kinetic friction and the coefficient of static friction of the flexible joint assembly. The disclosed flexible joint assemblies may be characterized by a coefficient of kinetic friction that is sufficiently low to allow a mounted object to freely move and achieve a parallel orientation upon contact of the object to a surface. The flexible joint assemblies may be further characterized by a coefficient of static friction that is sufficiently high to resist motion and allow the object to maintain the parallel orientation after contact with the surface is broken. Coefficients of kinetic and static friction can depend upon the choice of materials used for the components of the flexible joint assemblies as well as the surface characteristics (e.g., surface roughness) of those materials. Regarding surface roughness, a “rough” material has surface features that, at the microscale and nanoscale, can be thought of like the teeth of a gear. During the leveling process, the object mounted to the support structure can assume discrete planar positions that correspond to the flexible joint assembly slipping to various “gear” positions. Any rigid material may be used for the components of the flexible joint assemblies. Suitable materials include, but are not limited to, stainless steel, aluminum, plastics, and ceramics.

The flexible joint assemblies can be formed from a variety of components. By way of example only, the flexible joint assembly can include a ball and a joint member mounted to the ball, wherein the joint member has a depression shaped to accommodate the ball as the ball rests against the joint member. A variety of joint members may be used. As one example, a joint member may include a pair of rods separated by a sufficient distance to accommodate a ball set atop the pair of rods. As another example, a joint member may include a socket having a hollow to accommodate a ball resting within the hollow. The hollow of the socket can take on a variety of shapes, including but not limited to a concave shape, a linear grooved shape, and a triangular grooved shape. As yet another example, a joint member may include a triangular arrangement of three balls separated by a sufficient distance to accommodate a ball set atop the center of the triangle. In all the examples, the flexible joint assembly provides a range of motion for an object mounted to the flexible joint assembly as the ball rotates within the depression of the joint member.

The flexible joint assemblies can be magnetic joint assemblies such that at least one of the components of the assembly is magnetic. For those embodiments in which the flexible joint assembly includes a ball and a joint member, the ball, the joint member, or both may be magnetic. A variety of materials may be used, provided that the material is a magnet. Suitable materials include ultra-high pull, neodymium, and nickel-plated magnets. Such magnets are commercially available. When one component of the flexible joint assembly is a magnet, the other component can be composed of a material that is capable of being attracted to a magnet, including, but not limited to, steel.

The disclosed devices may include one flexible joint assembly or a plurality of flexible joint assemblies. Flexible joint assemblies may be mounted to the support structure by a variety of known means, including, but not limited to, adhesives, glues, or magnets.

Exemplary flexible joint assemblies are further described below and illustrated in the figures.

### Objects to be Mounted to the Support Structure

The objects to be mounted to the support structure include a plurality of protrusions, the protrusions adapted to form a pattern on a surface of a substrate upon contact of the object to the surface. The pattern can be a microscale or a nanoscale pattern. By “microscale” it is meant that the pattern includes, for example, a feature having a dimension on the order of microns, e.g., 1, 10, 100 μm, etc. By “nanoscale” it is meant that the pattern includes, for example, a feature having a dimension on the order of nanometers, e.g., 1, 10, 100 nm, etc. The pattern can include dots, lines, and circles having arranged in various irregular or regular orientations. Exemplary objects include stamps, including polymeric stamps, used in microcontact printing and molds used in nanoimprint lithography. Such stamps and molds are known in the art. The object may be an elastomeric tip array such as those described in Hong et al., “A micromachined elastomeric tip array for contact printing with variable dot size and density,” J. Micromech. Microeng. 18 (2008).

Another non-limiting exemplary object is an array of nanoscopic and/or scanning probe tips. The array may be a one-dimensional array of tips or a two-dimensional array of tips, including high density arrays of tips. See, e.g., U.S. Pat. Nos. 6,635,311 and 6,827,979 to Mirkin et al; U.S. Patent Application Pub. No. 2008/0105042 to Mirkin et al; and U.S. Patent Application Pub. No. 2008/0309688 to Haaheim et al. See also DPN 5000, NLP 2000, NSCRIPTOR™ and other nanolithography instrumentation sold by NanoInk (Skokie, Ill.). The tips can be solid or hollow, and can have a tip radius of, for example, less than 100 nm. Tips can be, but need not be, formed at the end of a cantilever structure. The cantilever can be mounted to a holder. The holder may include one or more viewports adapted for viewing the tips. The viewports may have a variety of shapes, sizes, and configurations as described in, e.g., U.S. Pat. Pub. No. 2008/0309688 to Haaheim et al. This reference also describes methods of making the viewports. The holder may also include one or more edge standoff spacers which help prevent crushing tips against the underside of the holder. Again, see, e.g., U.S. Patent Application Pub. No. 2008/0309688 to Haaheim et al.

Polymer pen arrays of tips are described in, for example, WO 2009/132,321 (PCT/US2009/041738) to Mirkin et al.

Objects, and support structure and other devices mounted to the object, as well as substrates, can be adapted to move with nanopositioners such as piezoresistor nanopositioners. Motion can be in x, y, and z directions, as well as rotational motions. See, e.g., U.S. Patent Application Pub. No. 2009/0023607, and The Nanopositioning Book. Moving and Measuring to Better than a Nanometre, T. R. Hicks et al, 2000.

The objects may be mounted to the support structure via a variety of known mounting means. By way of example only, adhesives, glues, or magnets may be used to mount the object to the support structure.

### Mounting Fixture

A separate mounting fixture adapted to facilitate the mounting of the object to the support structure can also be used. The mounting fixture can be useful when adhesives, glues, or similar mounting means are used to mount the object to the support structure. The mounting fixture can include a cavity adapted to hold the object in a fixed position while leaving a mounting surface of the object exposed during the mounting process. The mounting fixture can further include a channel adapted to accommodate a support structure placed onto the mounting surface of the object. The mounting fixture can further include a clipping member adapted to hold the support structure in a fixed position atop the mounting surface of the object during the mounting process. The overall shape and dimensions of the mounting fixture are not limited and can vary depending upon the shapes and dimensions of the object and the support structure to be mounted together using the mounting fixture. Similarly, the materials used to form the mounting fixture may vary. Any of the metals and plastics described herein may be used, although other similar materials are possible. Non-limiting examples of mounting fixtures are described below and illustrated in the figures.

### Other Components

The devices can include a variety of other components. By way of example only, the devices can include a mounting structure mounted to the at least one flexible joint assembly. The mounting structure can be adapted to be mounted to a patterning instrument. The shapes and dimensions of the mounting structure may vary. Non-limiting examples of mounting structures are described below and illustrated in the figures. Similarly, the materials used to form the support structures may vary. Suitable materials include, but are not limited to copper and the like. The mounting structure may be mounted to the flexible joint assembly and the patterning instrument in a variety of ways, including, but not limited to adhesives, glues, and screws.

The devices can further include a signaling system for signaling the orientation of the mounted object with respect to a surface. For example, the signaling system may be adapted to signal when a parallel orientation of the mounted object to a surface has been achieved. Non-limiting examples of signaling systems are described below and illustrated in the figures.

### Additional Embodiments

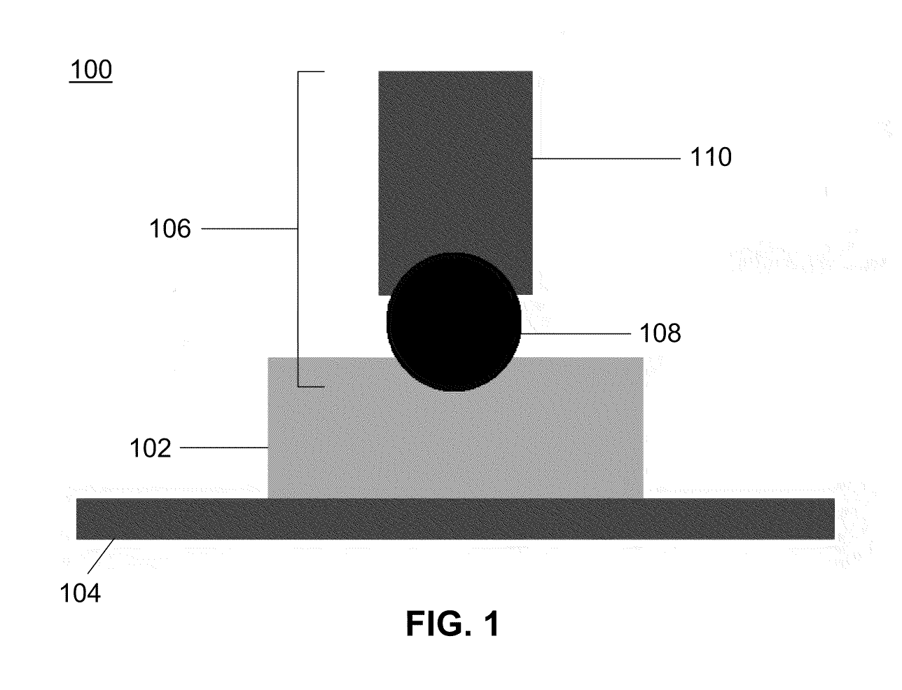

An embodiment of a device for leveling is illustrated in FIG. 1. As shown in FIG. 1, the device 100 includes a support structure 102 adapted to mount an object 104 and a flexible joint assembly 106 mounted to the support structure. The support structure 102 shown in FIG. 1 is a block, but other shapes may be used. Any of the objects described above may be mounted to the support structure, including an array of tips such as, for example, scanning probe tips, tips disposed on a cantilever, tips not disposed on a cantilever, and/or elastomeric tips. Although the disclosed devices are adapted to mount such objects, the devices need not include the object itself. As shown in FIG. 1, the flexible joint assembly 106 includes a ball 108 and a joint member 110 mounted to the ball. However, other flexible joint assemblies are possible. The joint member 110 includes a depression at one end, the depression shaped to accommodate the ball against the joint member. In FIG. 1, the flexible joint assembly is a magnetic joint assembly. Although either the ball or the joint member may be magnetic, in FIG. 1, the joint member 110 is a magnet and the ball 108 is a steel ball. Thus, the joint member and the ball are mounted via magnetic forces and the flexible joint assembly is capable of flexing in a variety of directions as the ball 108 rotates within the depression of the joint member 110. The ball 108 is mounted to the support structure 102 with an adhesive. However, other mounting means are possible. Thus, any flexing of the flexible joint assembly results in motion of the support structure mounted to the ball and the object mounted to the support structure.

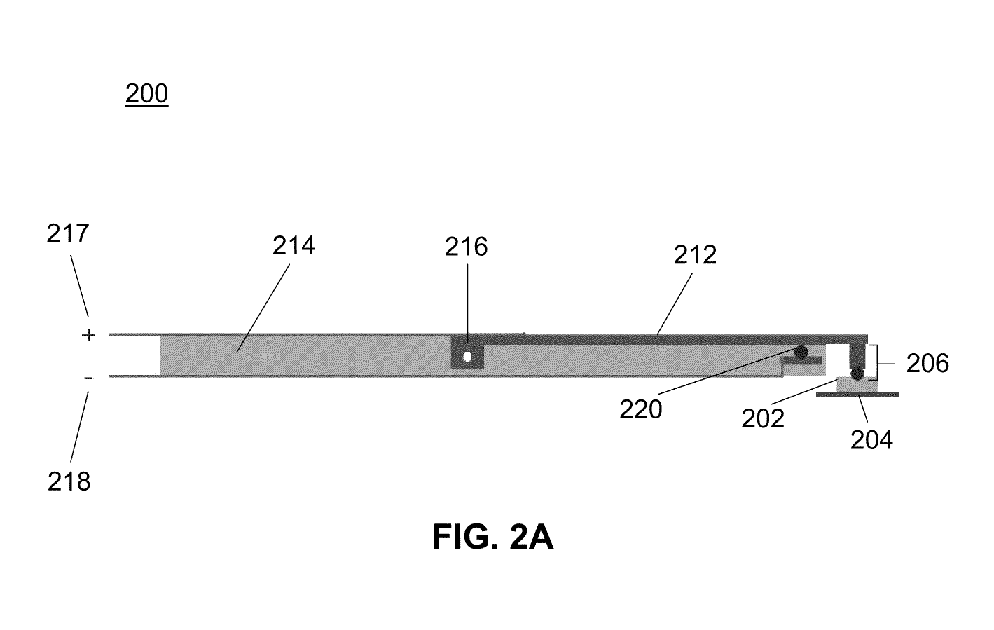

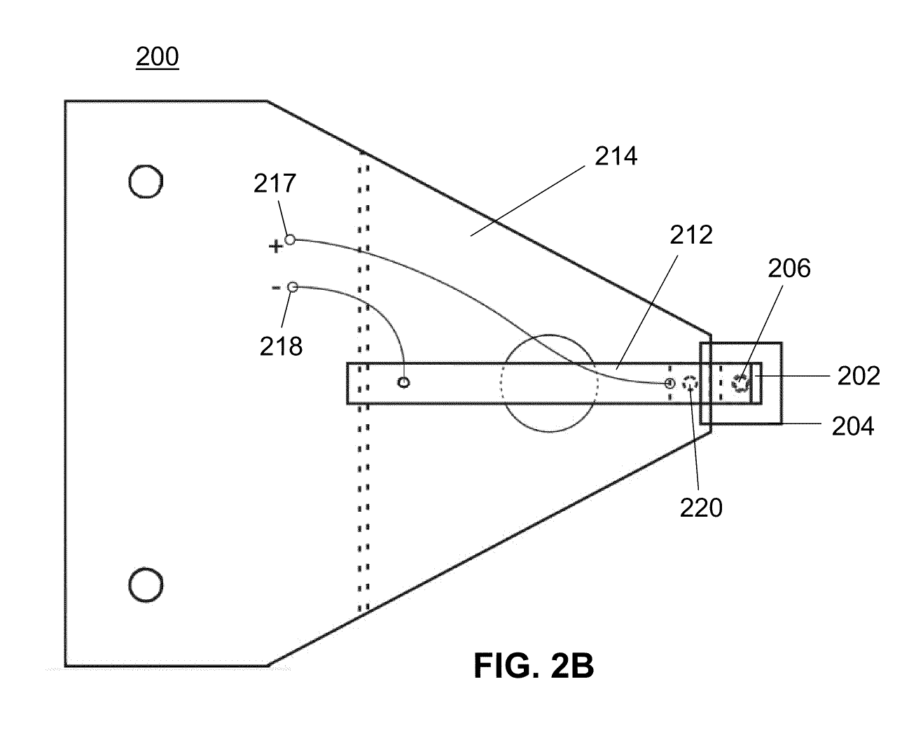

FIGS. 2A and 2B illustrate another embodiment of a device for leveling. As shown in FIG. 2A, the device 200 includes a support structure 202 adapted to mount an object 204 and a flexible joint assembly 206 mounted to the support structure. The device further includes a mounting structure 212 mounted to the joint member of the flexible joint assembly 206. The mounting structure is adapted to be mounted to a platform 214 of a patterning instrument (not shown) via a hinge member 216 at one end of the mounting structure. FIG. 2B shows a top view of the device, including the support structure 202, the object 204, the flexible joint assembly 206, and the mounting structure 212. FIG. 2B more clearly shows that in this embodiment, the mounting structure is in the shape of a beam, but other shapes are possible. Similarly, the mounting structure may be mounted to the patterning instrument via other means besides a hinge member 216.

FIGS. 2A and 2B also show the device for leveling integrated with a signaling system for signaling when a parallel orientation of an object mounted to the device has been achieved. The signaling system includes an electrical circuit. The electrical circuit is formed by an electrical source represented by a positive terminal 217 and a negative terminal 218; a light source (not shown) electrically coupled to the electrical source; the mounting structure 212 electrically coupled to the electrical source; and a supporting member 220 electrically coupled to the electrical source and adapted to support the other end of the mounting structure. A variety of known electrical sources and light sources may be used. By way of example only, an LED may be used as a light source. The shape and dimensions of the supporting member may vary, provided that the supporting member can support the end of the mounting structure. The composition of the supporting member and the mounting structure may also vary, although conductive materials are desirable for forming the electrical circuit of the signaling system.

Other signaling systems for signaling when a parallel orientation has been achieved and for providing associated quantitative information are possible. Such signaling systems can be integrated with any of the devices disclosed herein. As one example, a signaling system can include means for a deflection measurement. A device integrated with such a signaling system can include a rigid arm coupled to the device. The arm can be adapted to protrude outwardly from the device. The arm can be further adapted to measure the movement of the device when the device comes under load. For example, the arm can be coupled to a deflection measurement device such as a digital encoder or a capacitive sensor for measuring movement. When the device makes contact with the surface of the substrate and the protrusions on an object mounted to the device begin to deflect and apply force upward on the arm, very small deflections of the arm can be measured.

As another example, a signaling system can include means for a strain gauge measurement. A device integrated with such a signaling system can include a strain gauge coupled to the device, the strain gauge adapted to measure the applied force and quantify the touch down point when the device and substrate make contact. Alternatively, the device can include pressure sensors coupled to a substrate to be contacted by the device. The pressure sensors can be adapted to provide information about when and where protrusions on an object mounted to the device begin applying a force on the substrate.

The leveling process will now be described, with reference to FIGS. 2A and 2B. The mounted object 204 may be brought into contact with a substrate (not shown) disposed underneath the object. Contact between the object and the surface of the substrate may be achieved in a variety of ways, including by lowering the device (and thus, the mounted object) towards the substrate or by raising the substrate towards the device. By way of example only, a substrate may be mounted on a moveable stage of a patterning instrument. As the substrate and the mounted object make contact, the ball of the flexible joint assembly 206 rotates within the depression of the joint member, thereby allowing the mounted object to achieve a parallel orientation with respect to the substrate. Thus, the device is capable of “self-leveling,” meaning that leveling is achieved by the freedom of motion provided by the flexible joint assembly and the force the mounted object and the substrate exert on each other during contact.

The signaling process will now be described, also with reference to FIGS. 2A and 2B. Before the mounted object achieves a parallel orientation, the mounting structure 212 rests on, and is in contact with, the supporting member 220. In this configuration, a closed electrical circuit is formed between the electrical source 217, 218, the mounting structure 212, the supporting member 220, and the light source, thereby causing the light source to “turn on.” After the mounted object achieves a parallel orientation with respect to the substrate, any further perpendicular motion of the substrate and object against each other will cause the mounting structure to be lifted off of the supporting member. This “lift off” opens the electrical circuit, thereby causing the light source to “turn off.” Thus, the light source provides a signal that the parallel orientation of the object with respect to the substrate has been achieved.

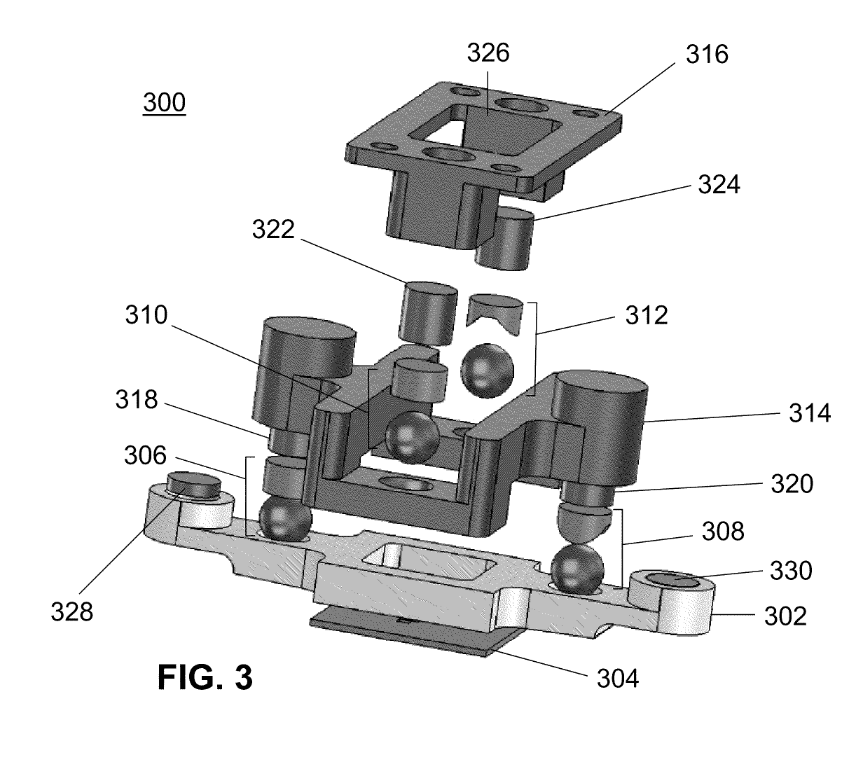

Another embodiment of a device for leveling is shown in FIG. 3. The device 300 includes a support structure 302 adapted to mount an object 304, and a plurality of flexible joint assemblies 306, 308, 310, and 312 mounted to the support structure. A central axis can be defined around which the flexible joint assemblies are disposed. Two axes can be defined as perpendicular to the central axis, and these two axes are perpendicular with each other and can be used to define the position of the flexible joint assemblies. In addition, two perpendicular planes can cut through the central axis, and the flexible joint assemblies can reside on these planes. The first flexible joint assembly 306 is positioned along a first axis parallel to the support structure 302 and the second flexible joint assembly 308 is positioned along this first axis and opposite to the first flexible joint assembly 306. The third flexible joint assembly 310 is positioned along a second axis parallel to the support structure 302 and perpendicular to the first axis and the fourth flexible joint assembly 312 is positioned along this second axis and opposite to the third flexible joint assembly 310. As in FIG. 2, each of the flexible joint assemblies of FIG. 3 includes a ball and a joint member, the joint member having a depression shaped to accommodate the ball within the depression. However, other flexible joint assemblies are possible. FIG. 3 shows in this embodiment, the joint members are sockets and the sockets of the second 308 and fourth 312 flexible joint assemblies have two opposing long sides and two opposing short sides. However, other types of joint members are possible. The shape of the joint member of the second flexible joint assembly 308 shown in FIG. 3 can facilitate rotation of a mounted object 304 about the second axis, but restrict rotation of the mounted object about the first axis. Similarly, the shape of the joint member of the fourth flexible joint assembly 312 shown in FIG. 3 can facilitate rotation of the mounted object about the first axis, but restrict rotation of the object about the second axis.

The flexible joint assemblies in FIG. 3 can be magnetic joint assemblies. Although either the ball or the joint member may be magnetic, in FIG. 3, the balls are magnetic and the joint assemblies are formed of a material, e.g., steel, capable of being attracted to a magnet. Thus, as described above, the joint member and the ball are mounted via magnetic forces and the flexible joint assemblies are capable of flexing in a variety of directions as the balls rotate within the depressions of their respective joint members. The balls of the first 306 and second 308 flexible joint assemblies can be mounted to the support structure 302 with an adhesive. However, other mounting means are possible.

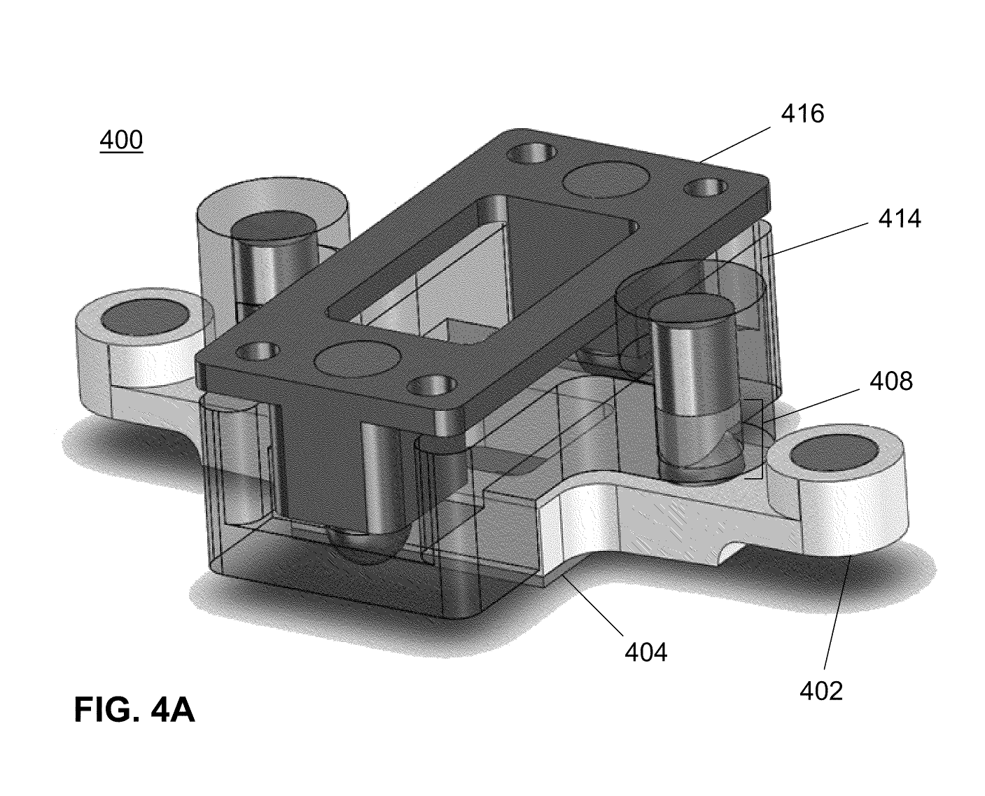

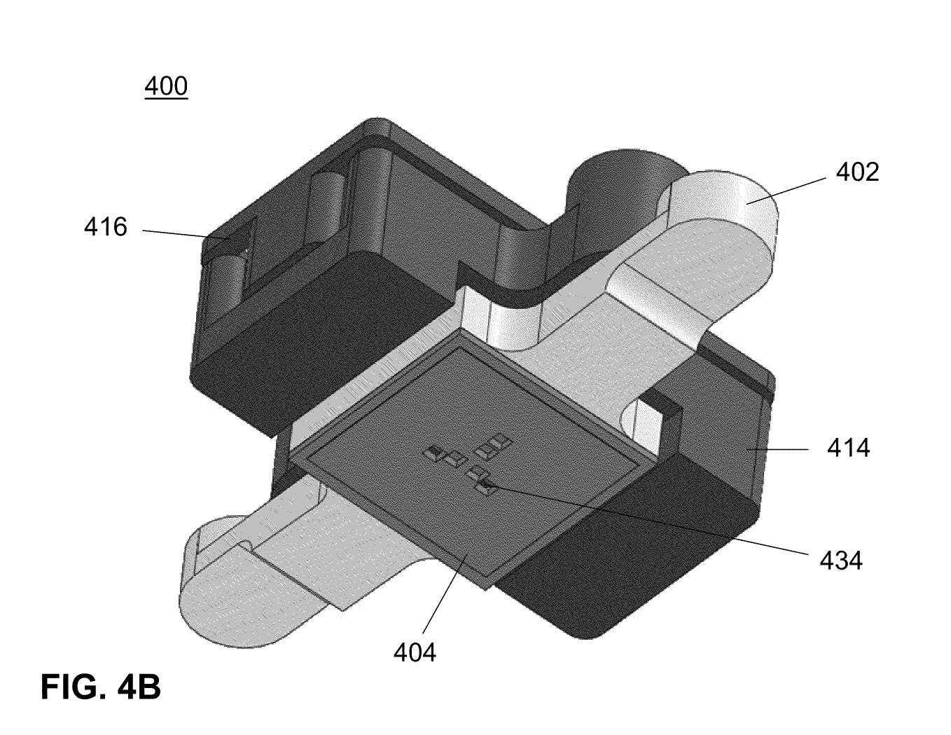

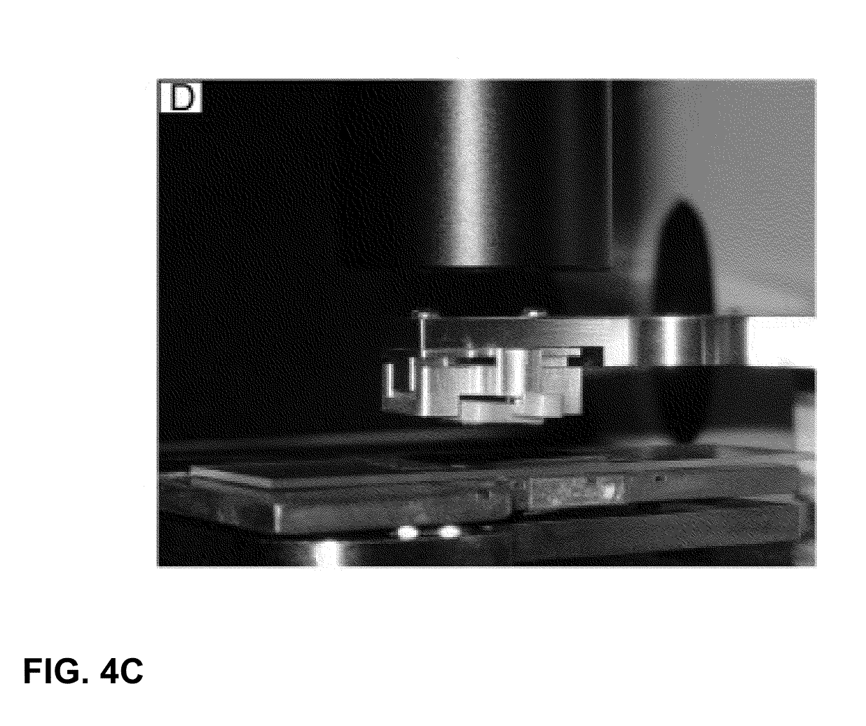

As shown in FIG. 3, the device can further include a middle structure 314 positioned above the support structure 302 and mounted to the first 306 and second 308 flexible joint assemblies. The device can further include an upper structure 316 positioned above the middle structure 314 and mounted to the third 310 and fourth 312 flexible joint assemblies. The shapes and dimensions of the support structure 302, the middle structure 314, and the upper structure 316 may vary. As shown in FIGS. 3 and 4A, these structures can have complementary shapes. In particular, the middle structure 314 can be shaped to fit around and accommodate at least a portion of the supporting structure 302 and the upper structure 316 so that the structures are “nested” when fully assembled. The particular shape of the support structure 302 and the middle structure 314 shown in FIG. 3 can also facilitate rotation of the object about the second axis (described above) while restricting rotation of the object about the first axis. Similarly, as shown in FIGS. 3 and 4A, the upper structure 316 can be shaped to fit within at least a portion of the middle structure 314 so that the upper structure and the middle structure are “nested” when fully assembled. The particular shape of the middle structure 314 and the upper structure 316 shown in FIG. 3 can also facilitate rotation of the mounted object about the first axis while restricting rotation of the object about the second axis. The balls of the third 310 and fourth 312 flexible joint assemblies can be mounted to the middle structure 314 with an adhesive. However, other mounting means are possible.

FIG. 3 also shows that the device can include additional mechanisms, embodiments, or means for mounting the middle structure 314 to the first 306 and second 308 flexible joint assemblies and for mounting the upper structure 316 to the third 310 and fourth 312 flexible joint assemblies. These mounting embodiments can be magnets 318-324 (318, 320, 322, 324), although other mounting embodiments are possible. As shown in FIG. 3, the first 318 and second 320 magnets can be positioned between the support structure 302 and the middle structure 314. The first 318 and second 320 magnets can be mounted to the middle structure 314 through a variety of means, including adhesive. The first 318 and second 320 magnets can then be mounted to the joint members of the first 306 and second 308 flexible joint assemblies, respectively, through magnetic forces. Similarly, the third 310 and fourth 324 magnets can be positioned between the middle structure 314 and the upper structure 316. The third 322 and fourth 324 magnets can be mounted to the upper structure 316 through a variety of means, including adhesive. The third 322 and fourth 324 can then be mounted to the joint members of the third 310 and fourth 312 flexible joint assemblies, respectively, through magnetic forces.

FIG. 3 shows that the magnets 318-324 (318, 320, 322, 324) and the flexible joint assemblies 306-312 (306, 308, 310, 312) form a “sandwich” type structure including a magnet, a joint member, and a ball. In the figure, the ball is also magnetic. An alternative sandwich structure is a magnet, a ball, and a joint member. In such a structure, the joint member could be magnetic. Thus, the ball could be a traditional steel ball bearing which can be machined to be more smooth than a magnetic ball. As described above, the smoothness of the structures of the flexible joint assembly affects at least the coefficient of static friction of the assembly, with a smoother ball providing a “gear” with smaller “teeth” and a low coefficient of static friction.

As shown in FIG. 3, the support structure 302, the middle structure 314, and the upper structure 316 may each include a central aperture 326 adapted to view an object 304 mounted to the support structure. As will be further described below, this feature can be useful as part of a signaling system to signal when a parallel orientation of the object with respect to a substrate has been achieved.

As described above, the support structure 302 can be further adapted to be mounted to an apparatus for disposing an ink composition on the plurality of protrusions. As shown in FIG. 3, the support structure 302 can include a pair of magnets 328, 330. These magnets may be used to mount the support structure (e.g., when it is dissembled from the device 300) to a variety of structures, including an apparatus for disposing an ink composition on the plurality of protrusions of the object to be leveled against a substrate. When the object is an array of tips such as scanning probe tips, the support structure can be mounted to an apparatus for vapor coating the tips via the magnets 328, 330. The tips can also be coated with a liquid coating using, for example, phospholipids.

FIGS. 4A-4C show a variety of perspective views of the assembled device shown in FIG. 3. FIG. 4A shows a perspective view of the top of the device 400, including the support structure 402 adapted to mount an object 404, a middle structure 414, and an upper structure 416. The middle structure 414 is shown as partially transparent to show the second flexible joint assembly 408. Only portions of the first, third, and fourth flexible joint assemblies are shown (not labeled). FIG. 4B shows a perspective view of the bottom of the device 400, including the support structure 402 adapted to mount an object 404, a middle structure 414, and an upper structure 416. FIG. 4B also shows that the object 404 includes a plurality of viewports 434 adapted to view one or more protrusions (not shown) on the object. As will be further described below, this feature can be useful as part of a signaling system to signal when a parallel orientation of the object with respect to a substrate has been achieved.

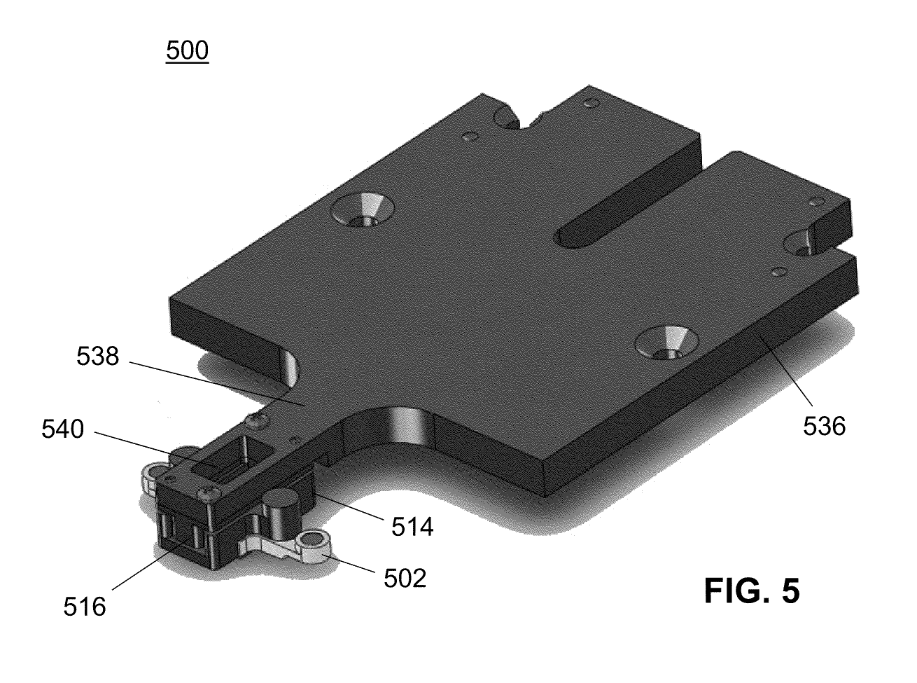

As described above, the leveling devices can include a mounting structure adapted to be mounted to a patterning instrument. Such a device 500 is shown in FIG. 5. The mounting structure 536 has a cantilever or beam structure 538 having an aperture 540, although other shapes are possible. FIG. 5 also shows the support structure 502, the middle structure 514, and the upper structure 516 of the device 500.

In some representative embodiments, the gimbal design only occludes the outer circumference of the object, such as an array of tips, such as for example a 2D nano PrintArray, leaving the internal viewing area free to be observed. Advantageously, this allows viewport deflection measurements to provide a useful form of corroboration for planarity. This design is different from the two-axis design or single-ball designs.

### Leveling Process

The leveling process will now be described, with reference to FIG. 3. The mounted object 304 may be brought into contact with a substrate (not shown) disposed underneath the object. Contact between the object and the surface of the substrate may be achieved in a variety of ways, as described above with reference to FIG. 2. By way of example only, a substrate may be mounted on a moveable stage of a patterning instrument and raised toward the mounted object 304 on the device 300. As the substrate and the mounted object make contact, the balls of the flexible joint assemblies rotate within the depressions of their respective joint members. As described above, the particular shapes of the support structure, 302, the middle structure 314, the upper structure 316, and the joint members of the second 308 and fourth 312 flexible joint assemblies allow rotation of the mounted object 304 about a first axis parallel to the support structure and a second axis parallel to the support structure and perpendicular to the first axis. This freedom of motion allows the mounted object 304 to achieve a parallel orientation with respect to the substrate upon contact.

The leveling devices can also be integrated with a signaling system for signaling when a parallel orientation of an object mounted to the device has been achieved. As described above, the device can include one or more apertures and an object mounted to the device can include one or more viewports, the apertures and viewports adapted to view one or more protrusions on the object. FIG. 3 shows a device 300 having an aperture 326 in each of the support structure 302, the middle structure 314, and the upper structure 316. FIG. 4B shows a device 400 with a mounted object 404 having a plurality of viewports 434. A signaling system for such a device can further include an optical device, such as a microscope, for facilitating viewing through the apertures and viewports. The system can also include cameras for further zoom capabilities and computers and imaging software for display capabilities. See, e.g., U.S. Patent Application Pub. No. 2008/0309688 to Haaheim et al.

An exemplary signaling process will now be described for a mounted array of scanning probe tips disposed on cantilevers using the signaling system described above. However, it is to be emphasized that the description below is not limited to an array of scanning probe tips disposed on cantilevers, but rather applies to any of the objects to be mounted to a support structure described herein and similar objects. Before the mounted array achieves a parallel orientation, the array of cantilevers and scanning probe tips as viewed through the viewports can appear out of focus. In addition, light reaching the cantilevers through the viewports can reflect off the cantilevers. The reflected light can have a particular color and intensity, providing an indication of the deflection state of the cantilevers. As the mounted array makes contact with the substrate and the array moves into a parallel orientation with respect to the substrate, the tips make contact with the substrate, and the cantilevers are deflected upwards. As the tips make contact with the substrate and the cantilevers deflect, the tips are brought into focus and the reflection of light off of the cantilever beams changes, resulting in a corresponding change in color and/or intensity. Any further perpendicular motion of the substrate and object against each other can cause further changes in light reflection and the tips to move out of focus. Thus, the imaging of the tips and/or cantilevers (at three different XY locations) provides a signal that the parallel orientation of the object with respect to the substrate has been achieved.

The objects, devices, and assemblies described herein can function as a gimbal.

Any of the devices described above can be assembled into apparatuses and kits. Use of the devices can be controlled by instruments, software, computers, and external hardware.

### Mounting Fixture

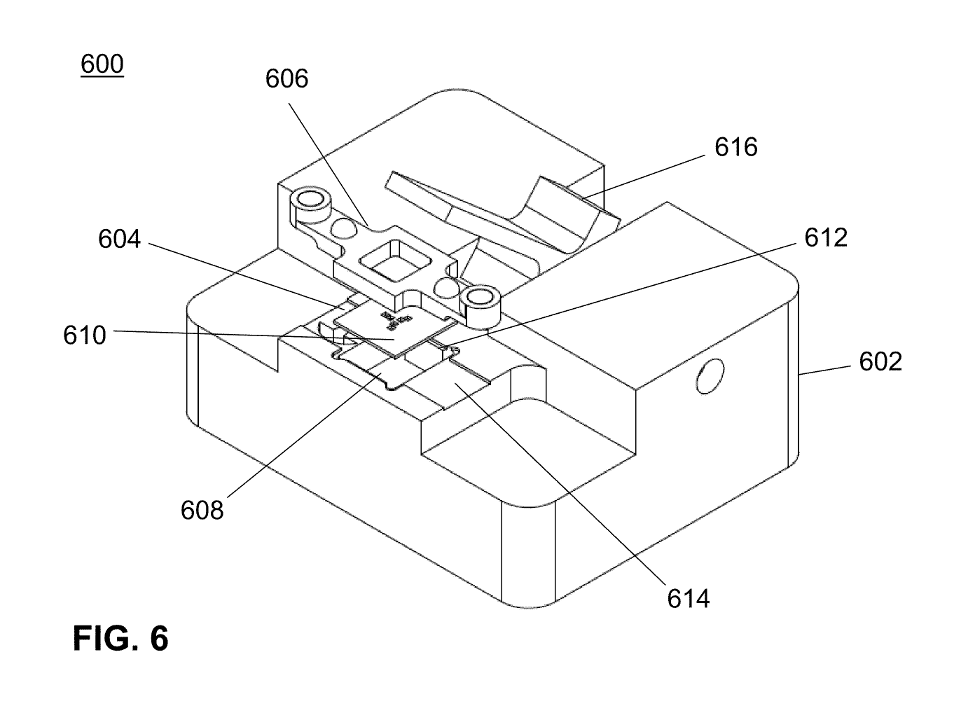

As described above, also provided are separate mounting fixtures adapted to facilitate the mounting of any of the disclosed objects to any of the disclosed support structures. An exemplary embodiment of a mounting fixture 600 is shown in FIG. 6. The mounting fixture 600 is adapted to facilitate the mounting of an object 604 to a support structure 606. The mounting fixture 600 includes a cavity 608 adapted to hold the object 604 in a fixed position while leaving a mounting surface 610 on the object exposed during the mounting process. The cavity 608 includes a lip 612 adapted to support the object 604 along at least a portion of the edge of the object. The plurality of protrusions (not shown) on the surface of the object opposite to the mounting surface 610 protrude into the cavity 608 during the mounting process. This can be useful to avoid handling of, and damage to, the protrusions during the mounting process. The mounting fixture 600 further includes a channel 614 shaped to accommodate a surface of a support structure 606 placed onto the mounting surface 610 of the object 604. The mounting fixture 600 can further include a clipping member 616 for holding the support structure 606 in a fixed position atop the mounting surface 610 of the object 604 during the mounting process. The shape and dimensions of the clipping member 616 are not limited, provided the clipping member is capable of contacting the support structure 606 atop the object 604 and of holding the support structure in place. The clipping member can comprise a spring effect.

An exemplary mounting process will now be described, with reference to FIG. 6. An object 604 can be placed onto the lip 612 of the cavity 608. An adhesive, glue, or other mounting means can be applied to the mounting surface 610 of the object 604. Next, a support structure 606 can be placed onto the mounting surface 610. If adhesive or glue or a similar mounting means is used, the clip 616 can be lowered onto the support structure 606 to hold the support structure against the mounting surface 610 of the object 604 while the adhesive or glue hardens or dries.

As noted throughout, the dimensions of the devices and components provided herein may vary. In some cases, the dimensions of the devices (e.g., the leveling devices, the mounting fixtures, etc.) and components of those devices (e.g., the object, the support structure, the middle structure, the upper structure, the flexible joint assembly, the joint member, the mounting structure, etc.) can be quite small, on the order of centimeters, millimeters, or even smaller. The small-scale manufacturing of devices and components having the ability to flex and move can be particularly challenging. By way of example only, the largest dimension of any of the devices herein can be about 10 cm or less. This includes embodiments in which the largest dimension is about 5 cm, 2 cm, 1 cm, or 0.5 cm. However, larger and smaller dimensions are also possible. As another non-limiting example, the largest dimension of any of the components herein can be about 5 cm or less. This includes embodiments in which the largest dimension is about 5 cm, 2 cm, 1 cm, 0.5 cm, or 1 mm. However, larger and smaller dimensions are also possible.

### Apparatuses

In another aspect, apparatuses incorporating the disclosed devices are provided. In some embodiments, the apparatus can include a patterning instrument and any of the devices described above, wherein the device is mounted to the patterning instrument. A variety of patterning instruments may be used, including, but not limited to, commercially available instruments for microcontact printing and nanoimprint lithography. Patterning instruments can also include scanning probe instruments adapted for patterning. Such scanning probe instruments include, but are not limited to, scanning tunneling microscopes, atomic force microscopes, and near-field optical scanning microscopes, all of which are commercially available. Other scanning probe instruments include the DPN 5000, NLP 2000, and the NSCRIPTOR systems commercially available from NanoInk, Inc., Skokie, Ill.

Another possible patterning instrument is described in U.S. Patent Application Pub. No. 2009/0023607 to Rozhok et al. Such an instrument can include at least one multi-axis assembly having at least five nanopositioning stages; at least one scanning probe tip assembly, wherein the scanning probe tip assembly and the multi-axis assembly are adapted for delivery of a material from the scanning probe tip assembly to the substrate, the substrate positioned by the multi-axis assembly; at least one viewing assembly; and at least one controller. Nanopositioning stages, multi-axis assemblies, scanning probe tips assemblies, viewing assemblies, and controllers are described in U.S. Patent Application Pub. No. 2009/0023607 to Rozhok et al.

Environmental chambers can be included on any of the patterning instruments described above, to control, for example, temperature, humidity, and gas content.

### Kits

One or more of the components and devices described herein can be combined into useful kits. The kits can further comprise one or more instructions on how to use the kit. The kit can be, for example, adapted to function with a patterning instrument such as an existing commercial patterning instrument.

### Methods

In another aspect, methods for using any of the disclosed devices and apparatuses are provided, including leveling methods and patterning methods. In an embodiment of a leveling method, the method can include providing any of the devices disclosed herein, mounting any of the disclosed objects to the support structure of the device, contacting the mounted object to a substrate, and allowing the object to achieve a parallel orientation with respect to the substrate surface. The step of contacting the mounted object can be accomplished as described above, e.g., moving the device and mounted object towards the substrate or moving the substrate towards the device and mounted object. The step of allowing the object to achieve a parallel orientation is accomplished as the flexible joint assemblies flex, and thus, the mounted object moves, in response to the force exerted by the mounted object and the substrate against each other.

The leveling method can include additional steps. By way of example only, the method can include confirming that the parallel orientation has been achieved by using any of the signaling systems described above. As another example, the method can include breaking contact of the mounted object with the substrate surface, wherein the parallel orientation of the mounted object is maintained after contact is broken.

In an embodiment of a patterning method, the method can include providing any of the devices disclosed herein, mounting any of the disclosed objects to the support structure of the device, providing at least some of the protrusions of the object with an ink composition, and transferring the ink composition from the protrusions to the surface of a substrate. Ink compositions are known and include organic compounds and inorganic materials, chemicals, biological materials, non-reactive materials and reactive materials, molecular compounds and particles, nanoparticles, materials that form self assembled monolayers, soluble compounds, polymers, ceramics, metals, magnetic materials, metal oxides, main group elements, mixtures of compounds and materials, conducting polymers, biomolecules including nucleic acid materials, RNA, DNA, PNA, proteins and peptides, antibodies, enzymes, lipids, carbohydrates, and even organisms such as viruses. Sulfur-containing compounds including thiols and sulfides can be used. Any of the references listed herein describe other ink compositions that may be used. Methods for providing protrusions with ink composition are known, including, e.g., solution dipping or vacuum evaporation. See, e.g., U.S. Patent Application Pub. No. 2005/0035983 to Cruchon-Dupeyrat et al. Parameters for transferring the ink composition from the protrusions to the substrate, e.g., dwell time, rate of forming patterns, and environmental conditions, are also known. Patterns can include dots, lines, circles, or other features. See, e.g., any of the references provided herein and U.S. Patent Application Pub. Nos. 2002/0063212 and 2002/0122873 to Mirkin et al.

The leveling methods and patterning methods can be combined. In one embodiment, any of the leveling methods described above can further include providing at least some of the protrusions of the object with an ink composition. The step of providing at least some of the protrusions with an ink composition can occur before or after contacting the mounted object to the substrate and allowing the object to achieve a parallel orientation. In other words, the protrusions can be coated with an ink composition before or after leveling the mounted object. In some embodiments, the protrusions are coated before leveling the mounted object. After the protrusions are coated and the mounted object is leveled, the methods can include transferring the ink composition from the protrusions to the substrate surface.

### Applications

The devices and apparatuses described herein can be used for a variety of applications, including biological applications, pharmaceutical applications, and fabrication of microscale and nanoscale structures. Fabrication applications include the formation of MEMS and NEMS. The acronym “MEMS” can encompass all microsystems, such as microelectromechanical, microelectrooptical, microelectromagnetic, and microfluidic systems. MEMS also can include nanoelectromechanical systems, NEMS. These and other applications are described in any of the references provided herein, including U.S. Patent Application Pub. No. 2008/0309688 to Haaheim et al.

For biological applications, cell growth, including stem cell growth, can be controlled with use of arrays fabricated with devices and instruments described herein. Protein arrays, nucleic acid arrays, and lipid and phospholipid arrays can be also fabricated.

### Methods of Making and Assembling

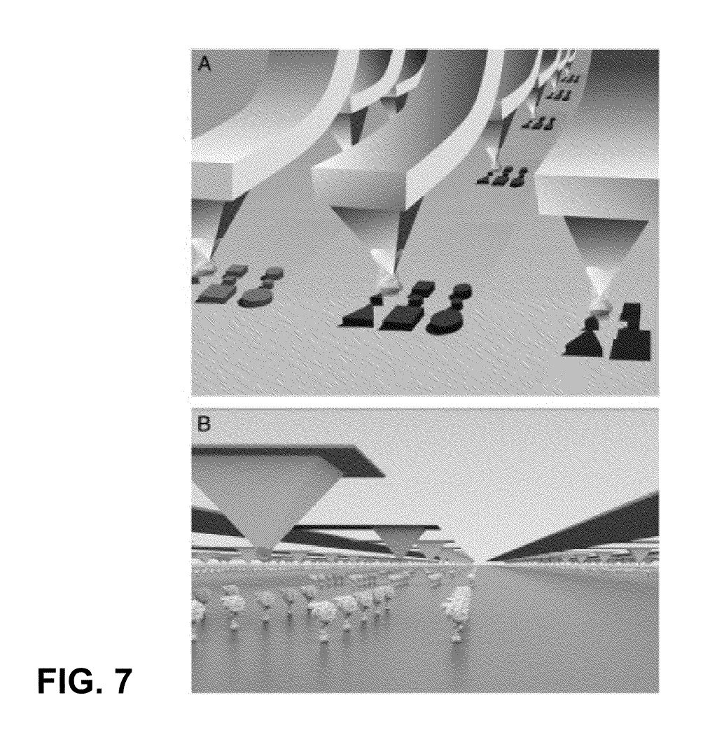

Methods known in the art can be used to make and assemble the components and devices described herein. This includes adapting the components and devices with commercial instrumentation. Additional non-limiting embodiments are described in FIGS. 7-17.

FIG. 7(A) illustrates the basic concept of multiplexed 2D-DPN—all tips draw the same shapes at the same time but each tip can be loaded with different ink. A small water meniscus is shown to represent a meniscus which can form between the tip and substrate in ambient conditions, and which is a vehicle for diffusion among classes of diffusive inks (e.g., alkane thiols). FIG. 7(B) narrows this idea to multiplexed printing of proteins, envisioning a rapid prototyping platform for creating tailor-made assay kits.

This concept—controlled and uniform contact—is important in terms of optimizing 2D-DPN. Traditional DPN with single tips or 1D arrays can be performed in force-feedback, with a laser bouncing off the cantilever and onto a photodetector to facilitate a constant applied force (i.e., cantilever deflection) with respect to the substrate. Due to the nature of mechanical amplification on an AFM, the range of cantilever deflection achievable in force-feedback is necessarily constrained by the dimensions of the photodetector; this cantilever deflection range is usually less than 2 μm. By contrast, 2D-DPN can be performed without force-feedback, where the Z-actuator is set at a constant height with respect to the substrate. Within the range of force-feedback conditions, DPN is effectively force independent, and patterns are created nearly identically between minimum and maximum deflections. However, in situations of extreme tip deflection (e.g., more than 10 μm), we have observed anomalous patterning behavior, including skewed features and non-standard formation of self-assembled monolayers (SAMs). This implies two very important operating conditions for creating uniform and homogenous patterns with 2D-DPN: (1) the overall Z-position of the 2D array must be carefully controlled with respect to the substrate (i.e., cantilever deflection average), and (2) the variation in cantilever deflection must be minimized (i.e., cantilever deflection variance, which is directly linked to array-substrate planarity). In one embodiment, the improved optics of the NLP 2000 make #1 easier to achieve; the self-leveling fixture improves the ease of achieving #2 while simultaneously enabling unprecedented planarity.

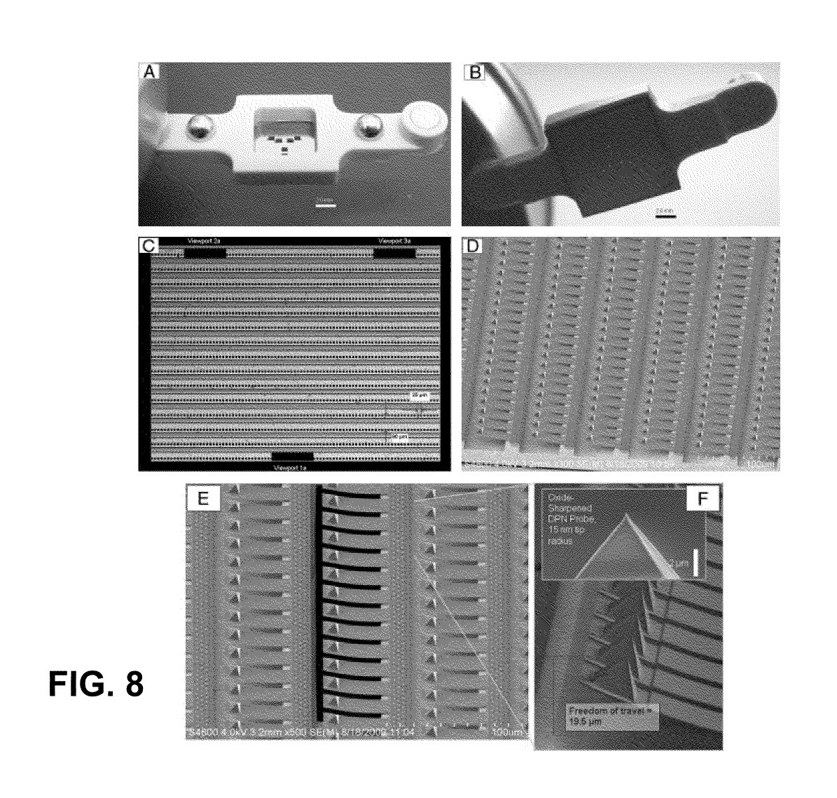

Beginning with the 2D nano PrintArray itself, FIG. 8(A) shows a top view of the silicon chip attached to a plastic handle. The handle is symmetric along the x-axis, with a large cutout in the middle to allow maximum light admission and viewing range for the chip's viewports. The viewports are arranged in a “Y,” such that one can make measurements from any of the legs of the “Y” to define the three points of contact with the substrate. FIG. 8(A) also shows the inset spherical ball magnets, which are used to attach the 2D nano PrintArray to the rest of the fixture. For convenience, storage, and transport, flat disk magnets are provided in the outer portion of the handle to allow the device to be safely attached to any magnetically permeable material; the device is shown suspended on its left side from the underside of a magnetically permeable metal tin. FIG. 8(B) provides a perspective of the same setup from below; the “Y” configuration of the viewports are visible as tiny slits of light coming through the top of the chip. FIG. 8(C) shows the inner three viewports (1a, 2a, 3a) explicitly. In this orientation, the coated tips (e.g., coated with alkane thiol like ODT) are pointed toward the viewer, and density of the cantilever packing is shown according to their 20×90 μm pitch arrangement.

The viewport width allows viewing one row of 13 adjacent cantilevers simultaneously; this greatly aides navigating to the substrate in Z, and across it in X and Y. The silicon nitride (SiN) cantilevers appear green in front of the green-yellow backdrop of the silicon handle wafer, and the pink areas of SiN provide the anchor to the handle. This arrangement is seen explicitly in FIG. 8(D): the rows of SiN cantilevers are attached to the ridges of the silicon handle wafer via a gold thermocompression bond. The areas underneath the cantilevers are etched away to provide maximum cantilever deflection. FIG. 8(E) zooms in on a group of cantilevers in front of the 260-μm wide viewport aperture, whereas FIG. 8(F) indicates the large FOT (typically 15-20 μm) available to each cantilever because of its high curl and the etched-away area beneath it. Solid SiN standoffs (4-μm height) are located at the outer corners of the device; these prevent the cantilevers from ever becoming fully deflected. All tips can be fabricated according to standard oxide sharpening processes, resulting in tip sharpness ˜15 nm (end radius).

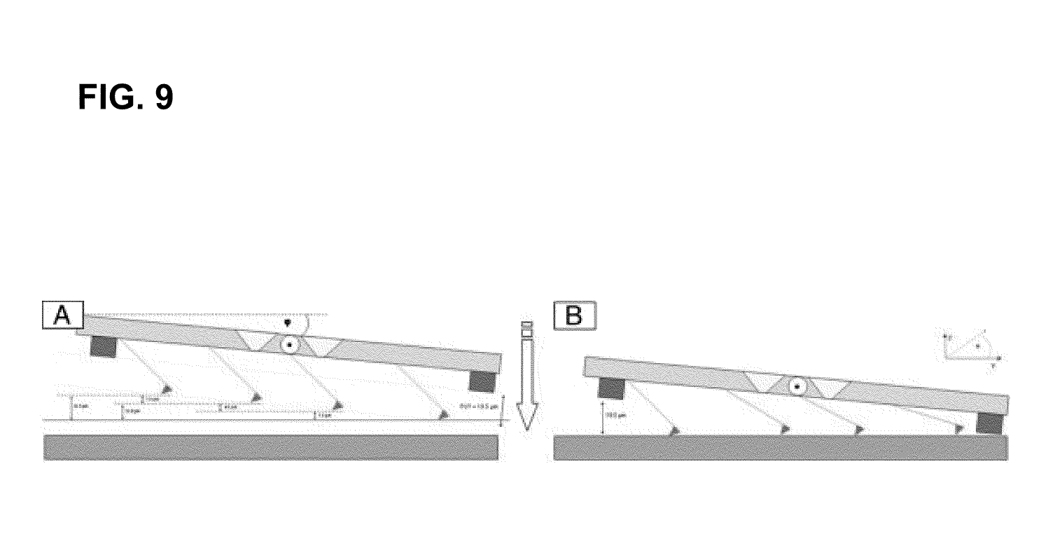

The FOT available to the cantilevers directly defines the minimum allowable planarity to get all of the tips in contact with the substrate. FIG. 9(A) shows a schematic of the array just before making contact with the surface, where the array is at the minimum angle (φ). The difference between the highest and lowest part of the array (DZ) is the same as the difference between the highest and lowest tip—19.5 μm. As the array moves toward the substrate, the tips on the right will begin deflecting in the order shown, moving left, until the leftmost tip just barely touches the surface. This happens simultaneously as the rightmost standoff touches.

FIG. 9(B) illustrates why large FOT cantilevers make the leveling process more forgiving. FIG. 9(B) also illustrates that to minimize the variance in cantilever deflection across the array, it may be necessary to minimize φ and make the device as planar as possible. Planarity is accomplished using the self-leveling fixture. The operating concept is that a fixture with two orthogonal axes of rotation (φₓ, φ_{y}) will accommodate the planarity of anything it physically encounters; with the 2D nano PrintArray, this occurs when all four SiN corner standoffs contact the substrate. FIG. 3 showed how all of the components fit together. The fixture comprises three main components: the top mount which is attached to the rigid probe-holder fixture, the middle gimbal, and the bottom handle which is glued to the 2D nano PrintArray. There are two points of contact between the middle and the top: the fixed spherical magnetic balls attach via a two-point kinematic mount to an inverted cone and a groove, both of which are magnetically permeable and have magnets mounted behind them. Similarly, there are two equivalent kinematic mount points of contact between the handle and the middle. The spherical balls that are fixed in the handle rotate freely along φₓ in their mounts, and the balls fixed in the middle piece rotate freely along φ_{y}. (It is noted that this self-leveling fixture is not functionally limited to only centimeter square arrays of cantilevers and tips; the generality of its design permits a variety of small-scale device leveling operations.) The magnet strength is calibrated to be weak enough to allow φₓ-φ_{y} rotation compensation to match the substrate planarity when the standoffs touch down, but strong enough to hold that precise planar orientation for all subsequent operations. FIG. 4(A) shows a transparent schematic of the device as it would actually be assembled, and FIG. 4(B) illustrates the same assembly from the underside where the exaggerated viewports are shown. FIG. 4(C) shows the real device as actually mounted; the 2D nano PrintArray and its handle are intentionally tipped forward along φₓ to illustrate the ranges of movement.

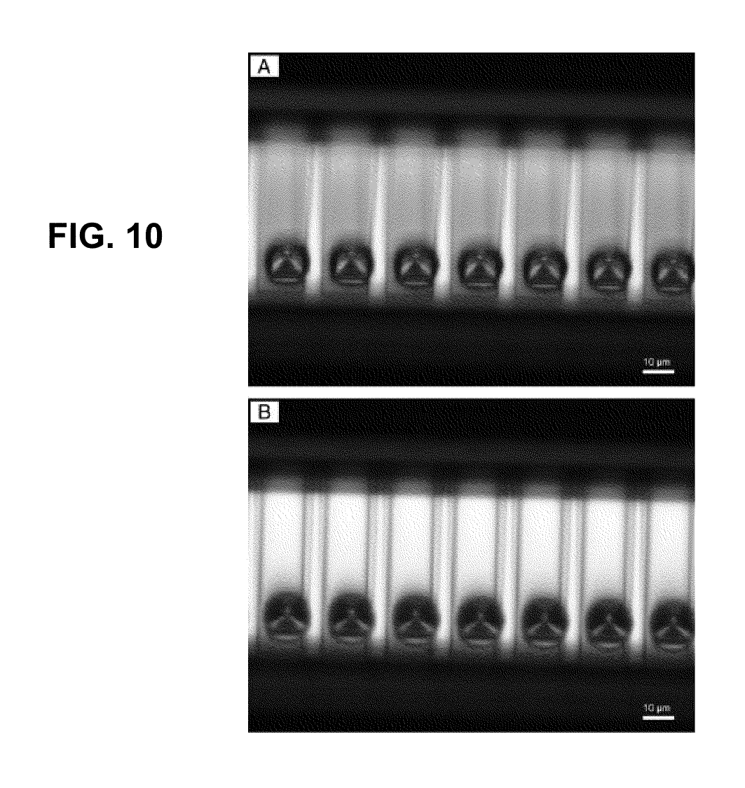

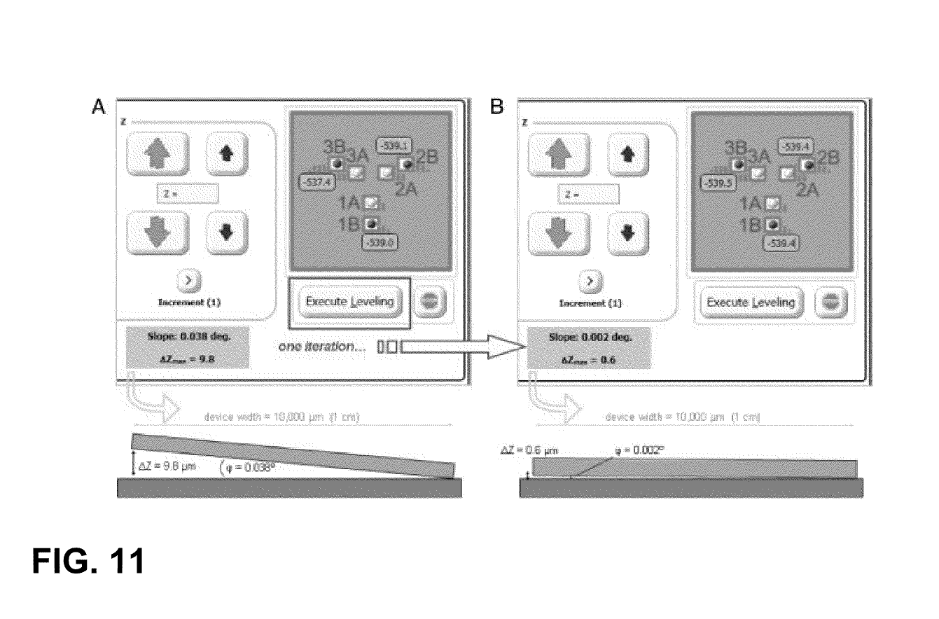

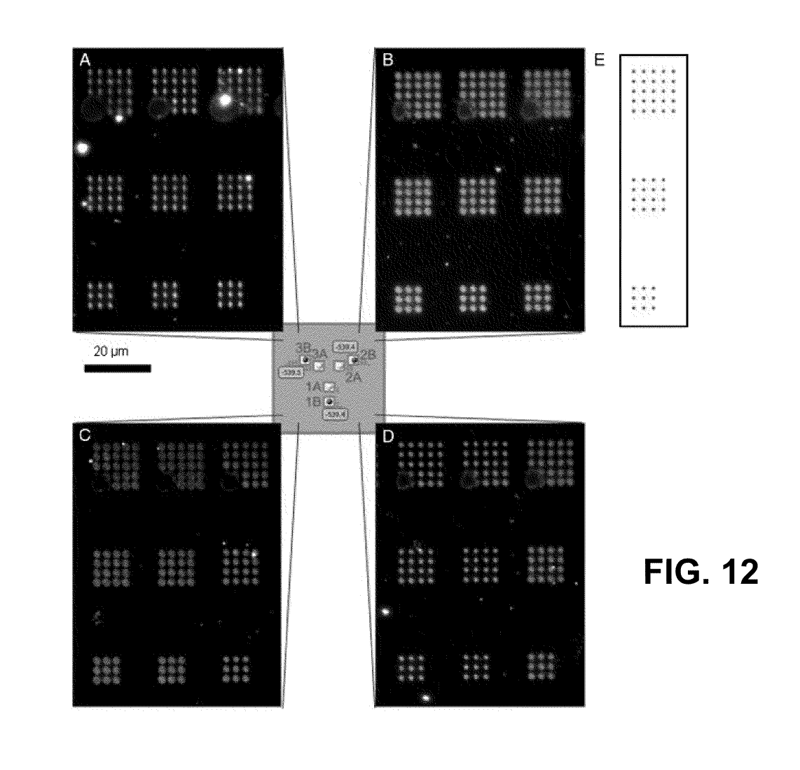

From this point, the leveling process is straightforward: one views the cantilevers through the viewports and brings the substrate upward in Z until it meets the first corner of the device, whereafter it self-levels as the cantilevers fully deflect. The cantilever deflection behavior can be seen in FIGS. 10(A and B); the cantilevers undergo a dramatic optical change indicative of surface contact. Maximizing this deflection correlates to making contact with all of the standoffs, and the device is then self-leveled. This is considered the “coarse-leveling” step. “Coarse-leveling” can be a relative term, however. FIG. 11(A) shows a representative schematic of the “coarse-level” situation. In this case, it is determined that the contact points at the viewports (1b, 2b, 3b) according to the deflection behavior shown in FIGS. 10(A and B). Notably, the clarity of the system optics allows the user to determine that point-of-contact to within ±100 nm so that the user can know how good the “coarse-leveling” actually was.

There are several optical indicators that enable that degree of precision: most prominently, the red-orange refracted light “butterfly wing” formation inside the pyramidal tip (FIG. 10(A)) changes shape and color dramatically as soon as the tip's position changes (in Z, tip, or tilt). The apparent color and intensity of the cantilever body will also change. The ease and clarity of these measurements enables the user to minimize surface contact time with these inked tips; alternatively, one can level the device in a sacrificial substrate area, and then translate 1 cm to the designated clean patterning area. At all times, the measurements are made by quickly actuating and retracting the Z-stage, noting whether the expected optical indicators manifested at that particular viewport. In FIG. 1(A), these point-of-contact measurements yield a set of three Z-coordinates (−539.0, −539.1, and −537.4) that describe the device's planarity; the software calculates the corresponding “slope” (φ) and ΔZ using the device dimensions. FIG. 11(A) shows these measurements taken immediately after coarse-self-leveling: with a slope of 0.0381 and ΔZ=9.8 μm, the “coarse level” result is actually very good. Not only is it as good as the best one could get with previous methods—wherein the ΔZ falls within the cantilever FOT (ΔZ=9.8 μm<FOT=19.5 μm), indicating that all of the tips can be touching—it is also below the extreme tip deflection limit (10 μm). If desired, one could have begun patterning immediately and achieved relatively homogeneous results.

However, this situation naturally lends itself to a “fine-leveling” step. Using the measured Z-coordinates from FIG. 11(A), the system can automatically adjust the φₓ-φ_{y} stages to correct for the slight measured misalignment (“Execute Leveling”). FIG. 11(B) shows the results measured immediately after the fine-leveling step: the slope of 0.002° and ΔZ=600 nm correspond to the cantilever deflection detection limit of ±100 nm. The device was as planar as could be measured with these methods. For scale comparison, ΔZ=0.6 μm across the device width of 10,000 μm is equivalent to 5 mm of ΔZ along the length of a football field.

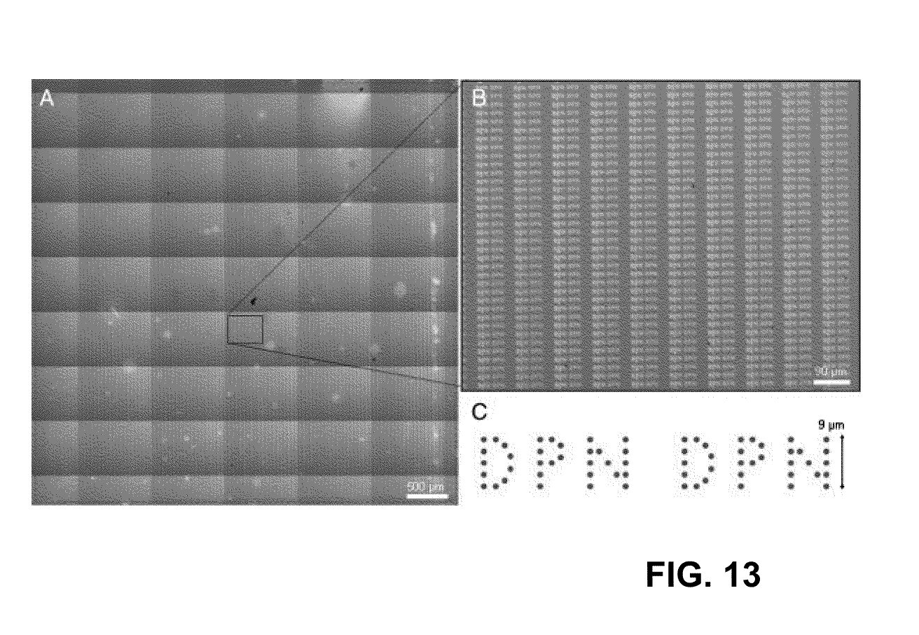

With the variation in cantilever deflection minimized (i.e., the device being extremely level), it was then straightforward to observe cantilever deflection at one viewport to calibrate the array's overall Z-position with respect to the substrate. (Cantilever deflection of 2 μm past the first contact point can be optimal.) Having satisfied the two important operating conditions for homogeneous patterning, subsequent results confirmed the expected homogeneity (FIGS. 12 and 13). FIG. 12(A-D) displays the dark field microscopy images obtained from the four corners of the overall centimeter-square pattern, as dictated by the software design input (FIG. 12(E)). The dot dwell times were 2 s, and the dot pitch was 3 μm. The dark field images show 15-nm thick gold structures on an SiO₂ substrate, with strong uniformity between the four corners.

The large spot in the bottom left corner of the 5×5 array was formed by dwelling on the substrate for several seconds before initiating patterning. FIG. 13(A) speaks to the overall uniformity across the entire square centimeter, with 56 bright field microscopy images tiled together to illustrate the consistency across the sample. In earlier works (e.g., Salaita et al. 2006), it was measured a feature size standard deviation of 16% across a centimeter square sample; the current work (FIG. 13(A)) shows a 5.4% standard deviation of feature size across the centimeter square sample, with measurements taken from all 56 image tiles. The central portion of the overall pattern is expanded in FIG. 13(B), revealing a new pattern based on the “DPN DPN” design from FIG. 13(C). (The dwell time for each dot was 20 s.) This level of homogeneity in printing from 55,000 tips is extremely difficult to achieve without appropriate leveling techniques. The self-leveling fixture makes it fast and easy.

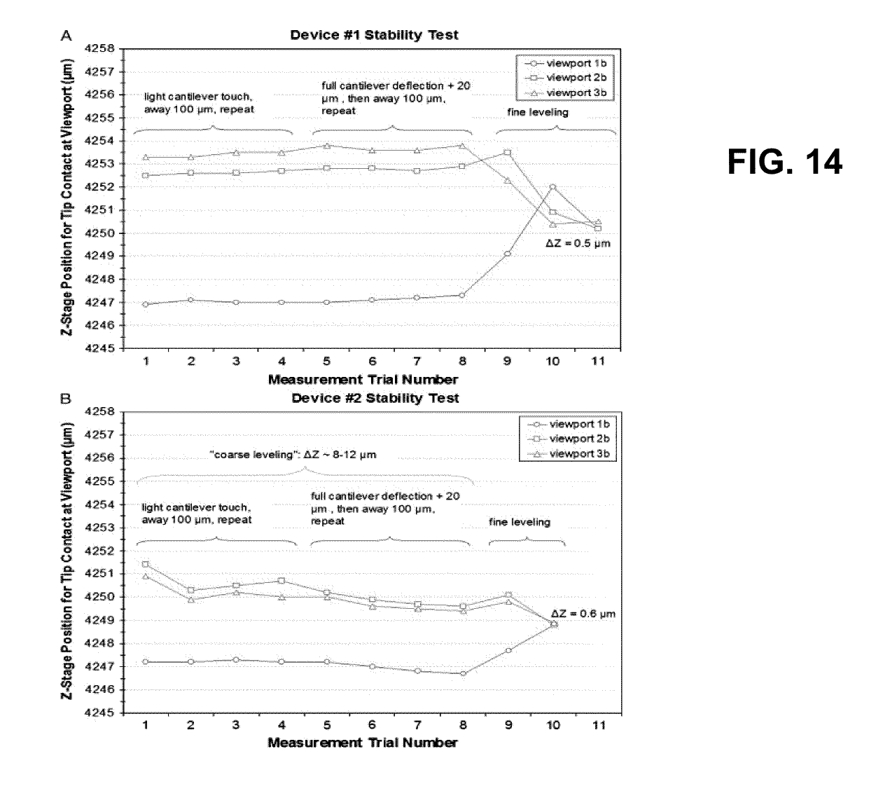

FIGS. 14(A and B) illustrates the self-leveling fixture's ability to maintain its arrived-at planarity across multiple lithography runs. The stability tests for self-leveling fixture #1 are shown in FIG. 14(A) and are a direct result of the precisely-calibrated magnet strength: if the magnets were too weak, the device would not be able to maintain the planar consistency in trials 1-8. In this experiment, the first four trials involved bringing the array into contact with the substrate, measuring the points of contact for the viewports (1b, 2b, 3b), withdrawing 100 μm, and repeating. Trials 5-8 involved bringing the array into contact with the substrate, moving 20 μm past full cantilever deflection, and then withdrawing 100 μm. The consistency of measured viewport positions means that the self-leveling fixture adopts a very stable orientation regardless of subsequent amounts of cantilever deflection. However, the discrepancy between viewport contact points is itself an indirect measurement of the self-leveling fixture's angular resolution, which is in turn representative of the material interfaces between the spherical magnetic balls and their kinematic mounts.

Trials 9-11 show the beginning of the fine-leveling steps, leading to the expected minimized ΔZ (0.5 μm). FIG. 14(B) shows the same behavior with a second device-fixture #2. This device shows the coarse-leveling results noted above (ΔZ˜8-12 μm), and similar planar orientation stability. One fine-leveling iteration achieves ΔZ=0.6 μm. The slightly different viewport spread seen in FIG. 14(B) results from a slightly different ball-mount material interface due to machining and polishing variations that are within normal tolerances.

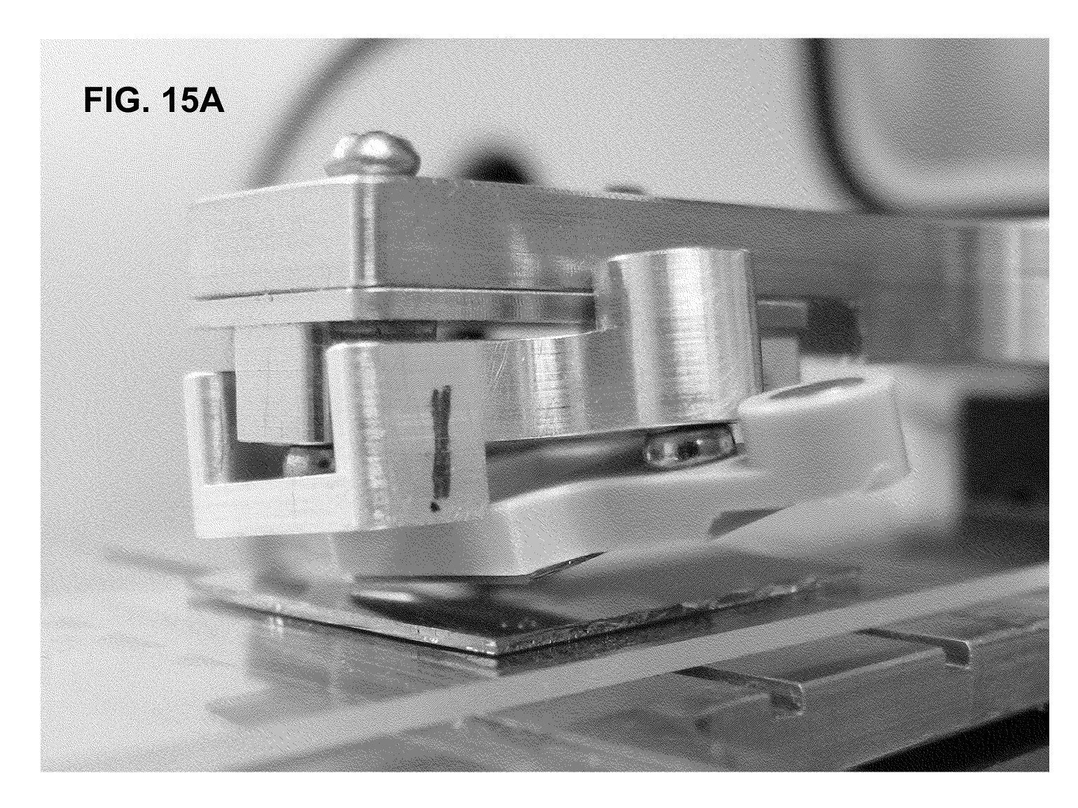

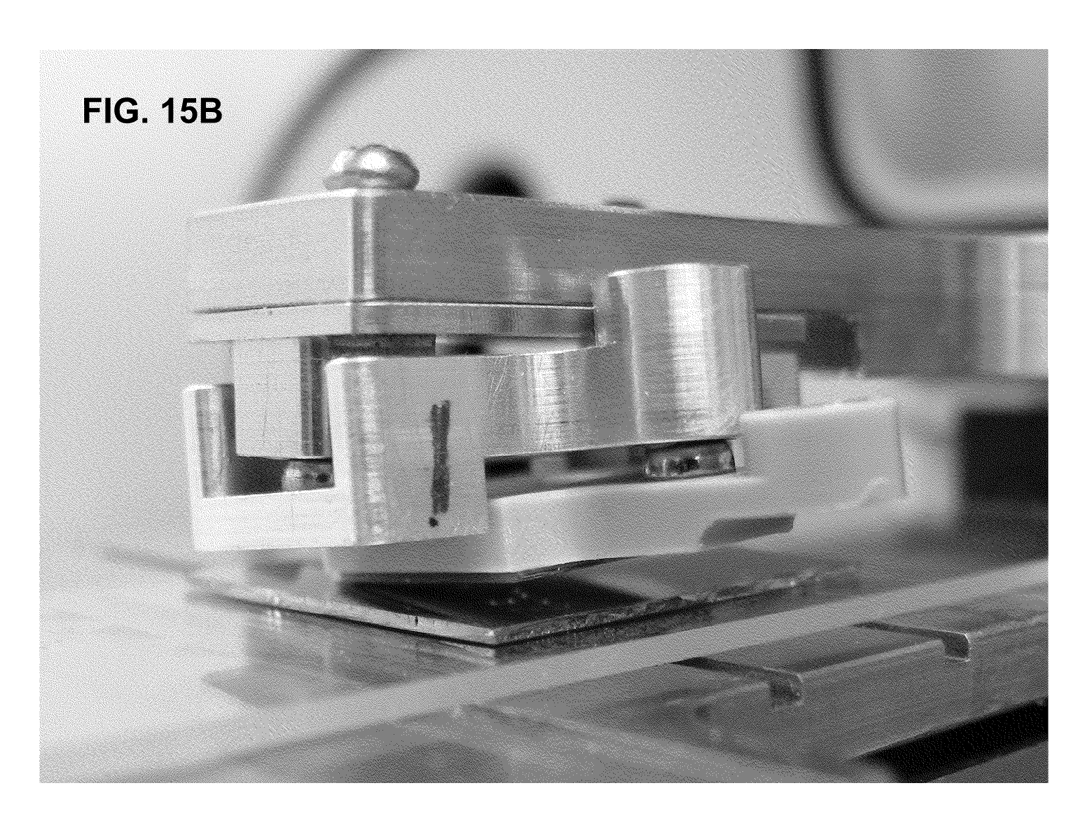

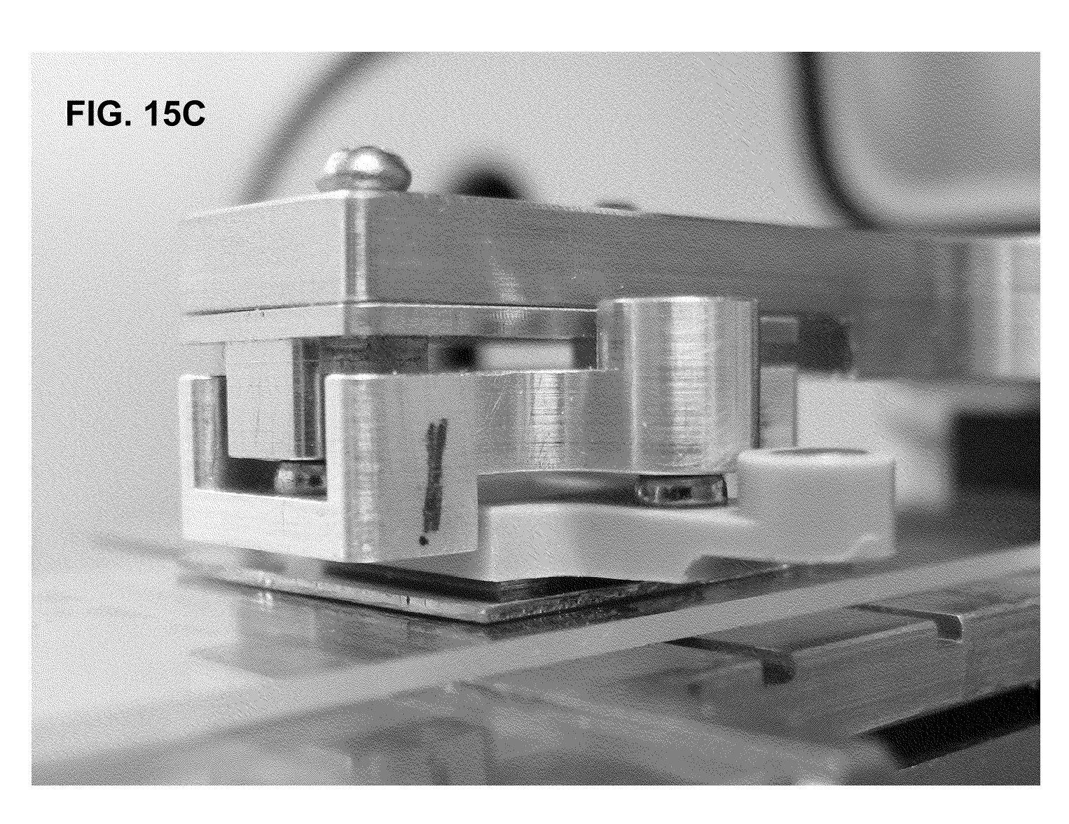

FIGS. 15A-C are photographs showing perspective views of the apparatus and the object during the self-leveling process. The strength of the magnets and the surface material lend a desirable range of rigidity to the setup, enabling the repeatable behavior shown in FIGS. 14A and 14B.

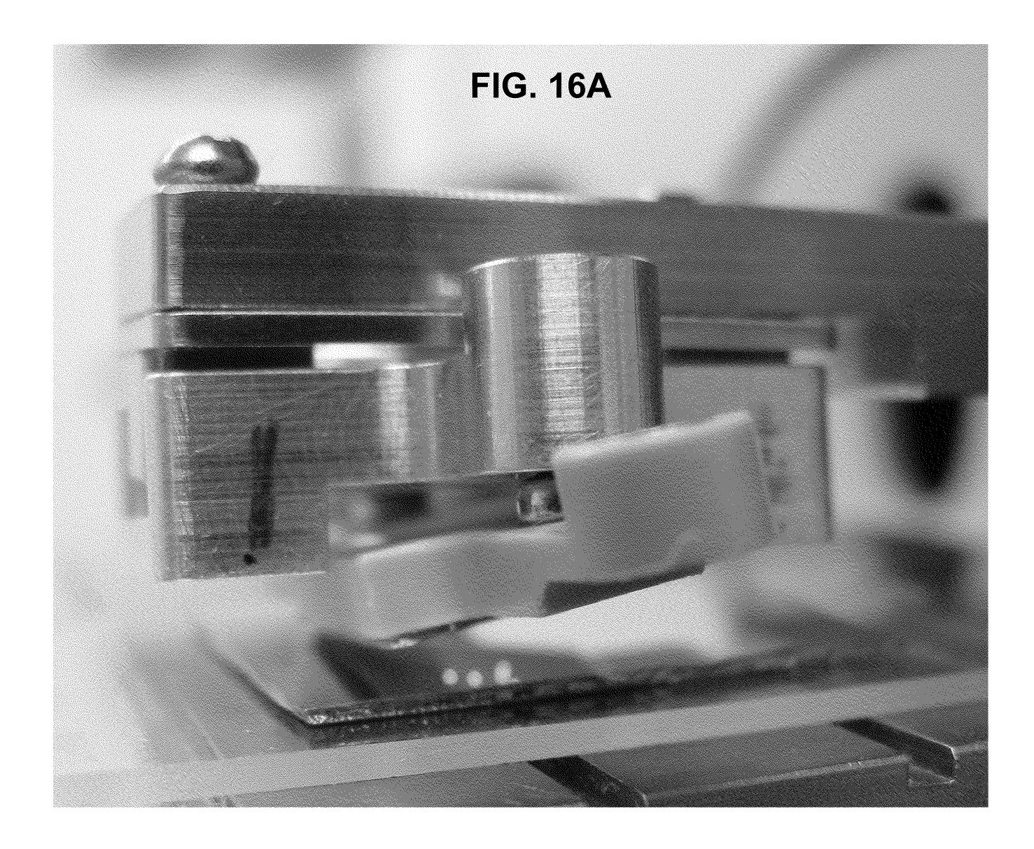

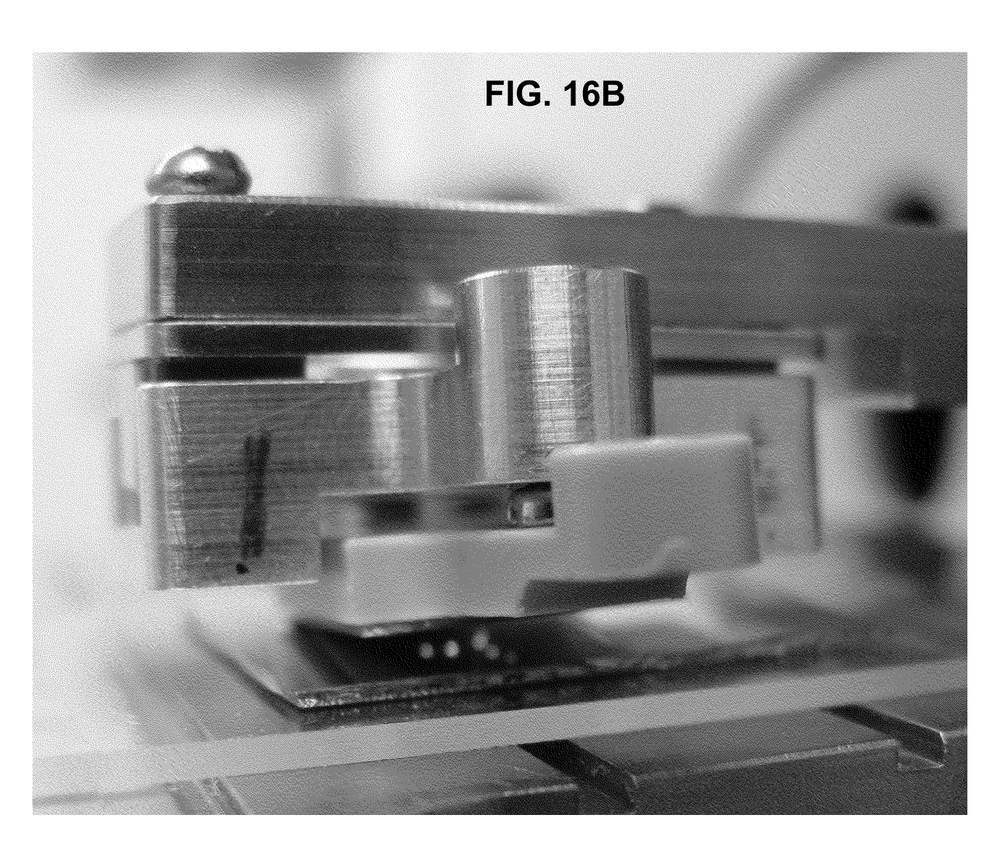

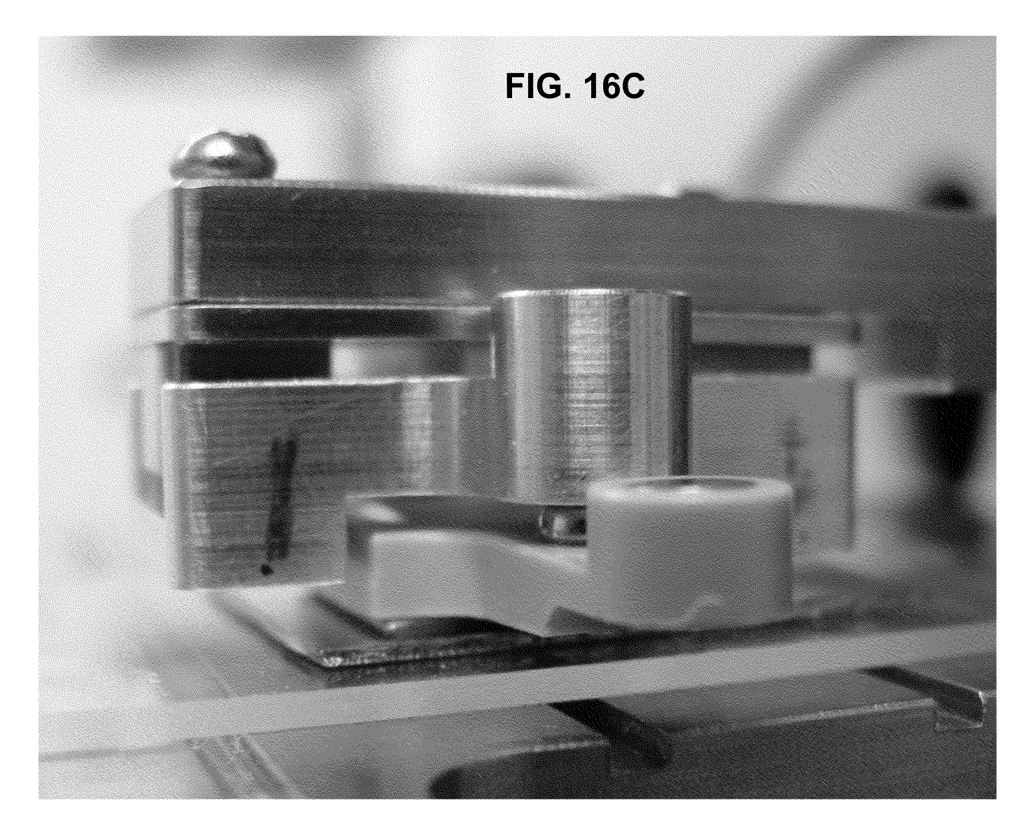

FIGS. 16A-C are photographs perspective views of the apparatus and the object during the self-leveling process.

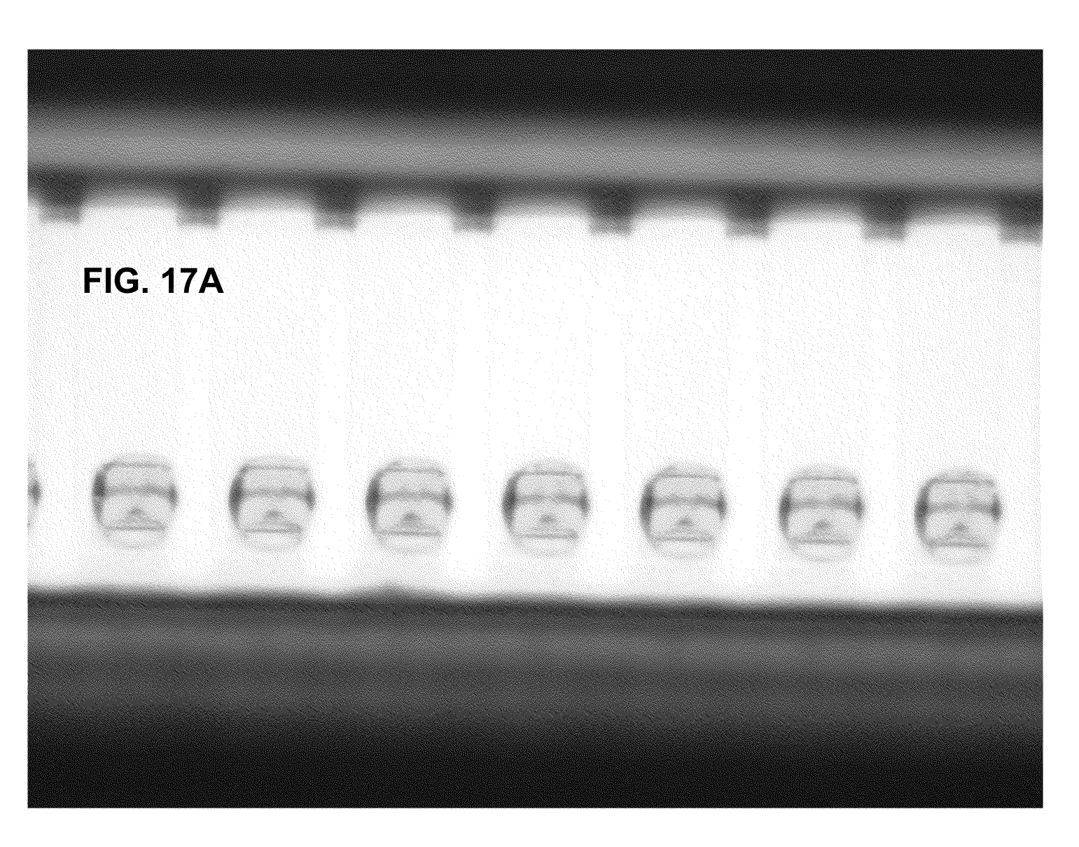

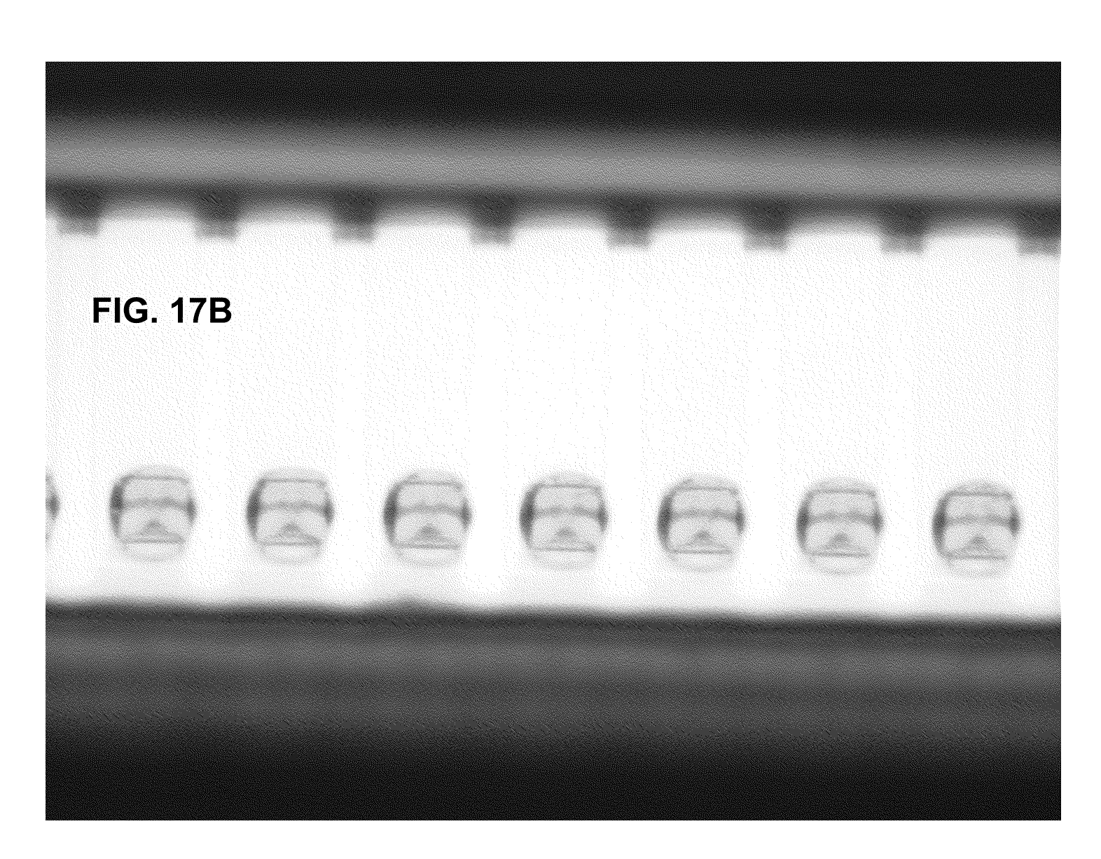

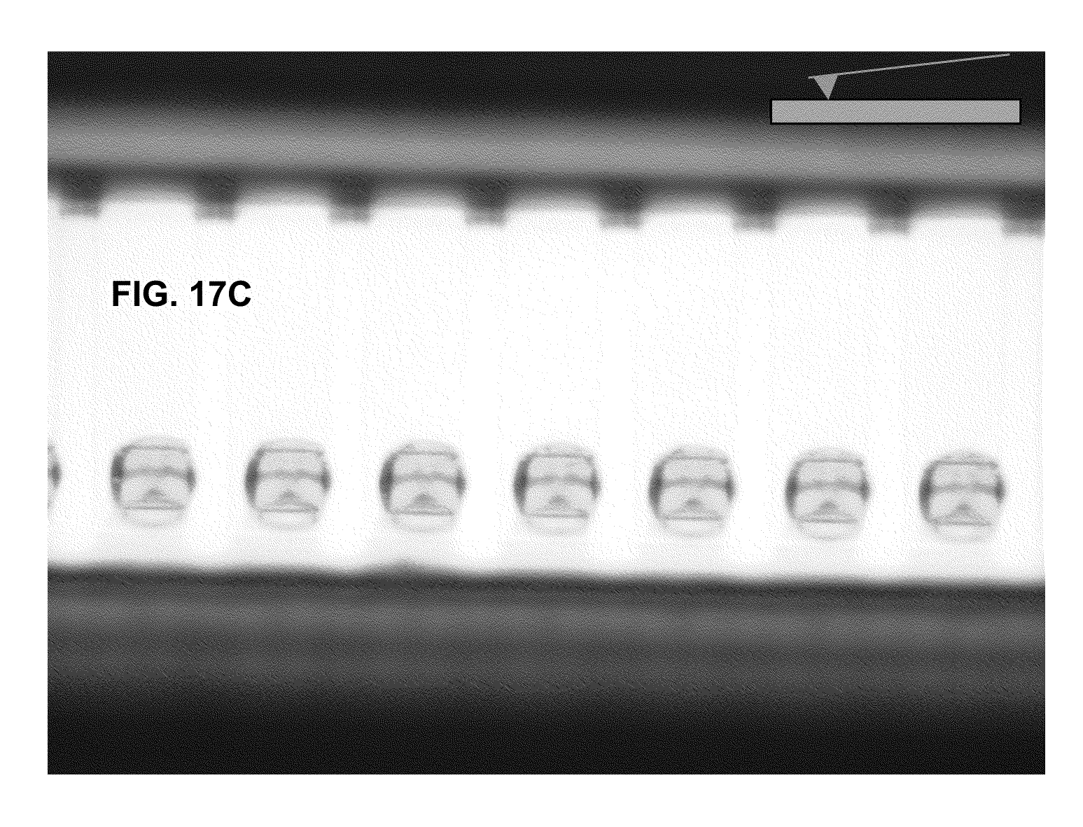

FIGS. 17A-C show the process of determining the first contact point by examining the “butterfly wing” light diffraction behavior from the protrusions (pyramids).

Hence, a variety of embodiments for a self-leveling fixture for 2D-DPN patterning is demonstrated that greatly minimizes the time required to level the device, simplifies the leveling procedure, and provides much better co-planarity than was previously achievable. Fine leveling routines can result in less than 0.002° misalignment with respect to the substrate—a Z-difference of less than 600 nm across 1 cm² of surface area. The degree of planarity directly correlates to homogeneity, which determines patterning quality across large areas. The ease and precision of this method enhances access to three categories of 2D nanopatterning applications mentioned above: (1) rapidly and flexibly generating nanostructures (e.g., Au, Si) via etch-resist techniques; (2) chemically directed assembly and patterning templates for either biological molecules (e.g., proteins, viruses, and cell adhesion complexes), or inorganics (e.g., CNTs, quantum dots); and (3) directly writing biological materials. Both phospholipids and alkanethiols have been patterned, with thiol functional groups including methyl, hydroxyl, amine, and carboxyl. One can thereby create hundreds of millions of chemically tailored nanostructures in a matter of minutes, with functional groups tailored to specific templating requirements.

To date, it is either very difficult or not possible to flexibly pattern a variety of materials at the DPN's resolution (14 nm) across centimeter square areas. Fundamentally, this enables flexible direct-writing with a variety of molecules, simultaneously generating large numbers (e.g., 55,000) duplicates at the resolution of single-pen DPN. By enhancing the speed, ease, and precision of the process, the self leveling methodology helps to enable practical nanomanufacturing.

### Materials and Methods

The 2D nano PrintArray devices as commercially available (NanoInk, Inc.) were used. Before patterning, the 2D tip arrays were vapor-coated with ODT, according to three coating cycles: 60 min at 65° C. and 100 min cool down at 0.1° C./min. The patterning was performed on the NLP 2000 (NanoInk, Inc.), which was used for capturing optical images of cantilever deflection behavior. Patterning was performed in ambient conditions (22° C., 30% Rh). Post-patterning, the substrate was etched to create metallic nanostructures, according to the published methods (e.g., Salaita et al. 2006). Scanning electron microscope images are obtained with a Hitachi 54800 SEM Tokyo, Japan. Bright field and dark field optical images are obtained with a Zeiss Axio-Imager ZIM Thonrwood, N.Y.

### REFERENCES

The following references further enable practice of various embodiments described herein and are incorporated by reference in their entirety.

Bullen et al.: Parallel dip-pen nanolithography with arrays of individually addressable cantilevers. Appl Phys Lett 84, 789-791 (2004).

Demers et al., Direct patterning of modified oligonucleotides on metals and insulators by dip-pen nanolithography. Science 296, 1836-1838 (2002).

Demers et al.: Orthogonal assembly of nanoparticle building blocks on dippen nanolithographically generated templates of DNA. Angew Chem Int Ed 40, 3071-3073 (2001).

Ginger et al.: The evolution of dip-pen nanolithography. Angew Chem Int Ed 43, 30-45 (2004).

Haaheim et al.: Dip Pen Nanolithography (DPN): process and instrument performance with NanoInk's NSCRIPTOR system. Ultramicroscopy 103, 117-132 (2005).

Haaheim et al. Scanning 30, 137-150 (2008).

Huck WTS: Self-assembly meets nanofabrication: recent developments in microcontact printing and dip-pen nanolithography. Angew Chem Int Ed 46, 2754-2757 (2007).

Lee K B, et al.: Protein nanostructures formed via direct-write dip-pen nanolithography. J Am Chem Soc 125, 5588-5589 (2003).

Lee K B, et al, Protein nanoarrays generated by dip-pen nanolithography. Science 295, 1702-1705 (2002).

Lenhert S: Materials integration by dip-pen nanolithography in Nanotechnology, Vol. 2—Nanoprobes. WILEY-VCH Weinheim, Berlin (2008).

Lenhert et al.: Massively parallel dip-pen nanolithography of heterogeneous supported phospholipid multilayer patterns. Small 3,71-75 (2007).

Nafday et al.: Site-specific dual ink dip pen nanolithography. Scanning 31, 122-126 (2009).

Piner et al.: Dip-pen nanolithography. Science 283, 661-663 (1999).

Rosner: Dip pen nanolithography: applications and functional extensions in Dekker Encyclopedia of Nanoscience and Nanotechnology. Taylor and Francis Group, New York (2005).

Salaita et al.: DPN-generated nanostructures as positive resists for preparing lithographic masters or hole arrays. Nano Lett 6,2493-2498 (2006a).

Salaita et al.: Sub-100 nm, centimeter-scale, parallel dip-pen nanolithography. Small 1,940-945 (2005).

Salaita et al.: Massively parallel dip-pen nanolithography with 55000-pen two-dimensional arrays. Angew Chem Int Ed 45,7220-7223 (2006b).

Salaita et al.; Applications of dip-pen nanolithography. Nat Nanotechnol 2,145-155 (2007).

Sanedrin et al.: Polyethylene glycol as a novel resist and sacrificial material for generating positive and negative nanostructures. Small 4, 920-924 (2008).

Sekula et al.: Multiplexed lipid dip-pen nanolithography on subcellular scales for the templating of functional proteins and cell culture. Small 4, 1785-1793 (2008).

Vega et al.: Monitoring single-cell infectivity from virusparticle nanoarrays fabricated by parallel dip-pen nanolithography. Small 3, 1482-1485 (2007).

Vettiger et al.: The “Millipede” more than one thousand tips for future AFM data storage. IBM J Res Develop 44, 323-340 (2000).

Wang et al.: Controlling the shape, orientation, and linkage of carbon nanotube features with nano affinity templates. Proc Natl Acad Sci USA 103, 2026-2031 (2006).

Wang et al.: Toward conductive traces: Dip Pen Nanolithographys of silver nanoparticle-based inks. Appl Phys Lett 93, 143105-1-143105-3 (2008).

Zhang et al.: High-throughput dip-pen-nanolithography-based fabrication of Si nanostructures. Small 3, 81-85 (2007).

Zhang et al.: Fabrication of sub-50-nm solid-state nanostructures on the basis of dip-pen nanolithography. Nano Lett 3, 43-45 (2003).

Zhang et. al.: Synthesis of open-ended, cylindrical Au—Ag alloy nanostructures on a Si/SiOx surface. Nano Lett 4, 1493-1495 (2004).

Zou S, et al.: Rings of single-walled carbon nanotubes: molecular-template directed assembly and Monte Carlo modeling. Nano Lett 7, 276-280 (2007).

What is claimed is:

1. A device comprising:
a support structure adapted to mount an object, the object comprising a plurality of protrusions adapted to form a pattern on a surface of a substrate upon contact of the object to the surface; and
at least one flexible joint assembly mounted to the support structure and adapted to allow the object to achieve a parallel orientation with respect to the surface upon contact of the object to the surface.

2. The device of claim 1, wherein the at least one flexible joint assembly is further adapted to maintain the parallel orientation after contact with the surface is broken.

3. The device of claim 1, wherein the object is an array of nanoscopic tips.

4. The device of claim 1, wherein the at least one flexible joint assembly is characterized by a coefficient of kinetic friction and a coefficient of static friction, and further wherein the coefficient of kinetic friction is sufficiently low to allow the object to move and achieve the parallel orientation upon contact of the object to the surface and the coefficient of static friction is sufficiently high to allow the object to maintain the parallel orientation after contact with the surface is broken.

5. The device of claim 1, wherein the at least one flexible joint assembly comprises
a ball; and
a joint member mounted to the ball, the joint member comprising a depression shaped to accommodate the ball.

6. The device of claim 1, wherein the at least one flexible joint assembly is a magnetic joint assembly comprising
a ball; and
a joint member mounted to the ball, the joint member comprising a depression shaped to accommodate the ball,
wherein the ball or the joint member is magnetic.

7. The device of claim 2, wherein the at least one flexible joint assembly is a magnetic joint assembly comprising
a ball and
a joint member mounted to the ball, the joint member comprising a depression shaped to accommodate the ball,
wherein the joint member is magnetic.

8. The device of claim 1, wherein the at least one flexible joint assembly comprises
a ball; and
a joint member mounted to the ball, the joint member comprising a depression shaped to accommodate the ball,
wherein the joint member is a socket.

9. The device of claim 1, further comprising a mounting structure mounted to the at least one flexible joint assembly, the mounting structure adapted to be mounted to a patterning instrument.

10. The device of claim 1, further comprising a mounting structure mounted to the at least one flexible joint assembly, the mounting structure adapted to be mounted to a scanning probe instrument.

11. The device of claim 1, further comprising a signaling system coupled to the device, the signaling system adapted to signal when the parallel orientation has been achieved.

12. The device of claim 11, wherein the signaling system comprises an electrical circuit comprising
an electrical source;
a light source electrically coupled to the electrical source;
a mounting structure mounted to the flexible joint assembly and electrically coupled to electrical source, the mounting structure adapted to be mounted to a patterning instrument via a hinge member at one end of the mounting structure; and
a supporting member electrically coupled to the electrical source and adapted to support the other end of the mounting structure.

13. A device comprising:
a support structure adapted to mount an array of nanoscopic tips, the array adapted to form a pattern on a surface of a substrate upon contact of the array to the surface; and
at least one magnetic flexible joint assembly mounted to the support structure comprising:
a ball; and
a magnetic joint member, the joint member comprising a depression shaped to accommodate the ball,
wherein the magnetic flexible joint assembly is adapted to allow the array to achieve a parallel orientation with respect to the surface upon contact of the object to the surface.

14. The device of claim 13, wherein the at least one flexible joint assembly is adapted to maintain the parallel orientation after contact with the surface is broken.

15. A device comprising:
a support structure adapted to mount an object, the object comprising a plurality of protrusions adapted to form a pattern on a surface of a substrate upon contact of the object to the surface; and
a plurality of flexible joint assemblies mounted to the support structure, the plurality of joint assemblies comprising:
a first flexible joint assembly positioned along a first axis parallel to the support structure;
a second flexible joint assembly positioned along the first axis and opposite to the first flexible joint assembly;
a third flexible joint assembly positioned along a second axis parallel to the support structure and perpendicular to the first axis; and
a fourth flexible joint assembly positioned along the second axis and opposite to the third flexible joint assembly;
wherein the plurality of flexible joint assemblies is adapted to allow the object to achieve a parallel orientation with respect to the surface upon contact of the object to the surface.

16. The device of claim 15, wherein the plurality of flexible joint assemblies are further adapted to maintain the parallel orientation after contact with the surface is broken.

17. The device of claim 15, wherein the object is an array of scanning probe tips.

18. The device of claim 15, wherein one or more of the flexible joint assemblies comprises:
a ball; and
a joint member mounted to the ball, the joint member comprising a depression shaped to accommodate the ball.

19. The device of claim 15, wherein one or more of the flexible joint assemblies is a magnetic flexible joint assembly comprising:
a ball; and
a joint member mounted to the ball, the joint member comprising a depression shaped to accommodate the ball,
wherein the ball or the joint member is magnetic.

20. The device of claim 15, wherein one or more of the flexible joint assemblies is a magnetic flexible joint assembly comprising:
a ball; and
a joint member mounted to the ball, the joint member comprising a depression shaped to accommodate the ball,
wherein the ball is magnetic.

21. The device of claim 15, wherein one or more of the flexible joint assemblies is a magnetic flexible joint assembly comprising:
a ball; and
a joint member mounted to the ball, the joint member comprising a depression shaped to accommodate the ball,
wherein the joint member is magnetic.

22. The device of claim 15, wherein each of the flexible joint assemblies comprises:
a ball; and
a joint member mounted to the ball, the joint member comprising a depression shaped to accommodate the ball,
wherein the joint member is a socket.

23. The device of claim 15, wherein each of the flexible joint assemblies comprises:
a ball; and
a joint member mounted to the ball, the joint member comprising a depression shaped to accommodate the ball,
wherein the joint member of the first and third flexible joint assemblies is a socket, and further wherein the joint member of the second and fourth flexible joint assemblies is a socket having two opposing long sides and two opposing short sides.

24. The device of claim 15, wherein the device further comprises:
a middle structure positioned above the support structure and mounted to the first flexible joint assembly and the second flexible joint assembly; and
an upper structure positioned above the middle structure and mounted to the third flexible joint assembly and the fourth flexible joint assembly.

25. The device of claim 24, wherein the shape of the support structure and the middle structure operate to allow rotation of the object about the second axis, but restrict rotation of the object about the first axis and the shape of the middle structure and the upper structure operate to allow rotation of the object about the first axis, but restrict rotation of the object about the second axis.

26. The device of claim 24, wherein the device further comprises a first magnet and a second magnet positioned between the support structure and the middle structure and a third magnet and a fourth magnet positioned between the middle structure and the upper structure, wherein the first magnet is mounted to the first flexible assembly, the second magnet is mounted to the second flexible assembly, the third magnet is mounted to the third flexible assembly, and the fourth magnet is mounted to the fourth flexible assembly.

27. The device of claim 24, wherein the support structure, the middle structure, and the upper structure each comprise a central aperture adapted to view the object.

28. The device of claim 24, further comprising a mounting structure mounted to the upper structure, the mounting structure adapted to be mounted to a patterning instrument.

29. The device of claim 24, further comprising a mounting structure mounted to the upper structure, the mounting structure adapted to be mounted to a scanning probe instrument.

30. The device of claim 15, wherein the support structure is adapted to be mounted to an apparatus for coating the plurality of protrusions.

31. The device of claim 15, wherein the support structure comprises one or more magnets for mounting the support structure to an apparatus for coating the plurality of protrusions.

32. A device comprising:
a support structure adapted to mount an array of nanoscopic tips, the array adapted to form a pattern on a surface of a substrate upon contact of the array to the surface;
a first magnetic flexible joint assembly mounted to the support structure and positioned along a first axis parallel to the support structure;
a second magnetic flexible joint assembly mounted to the support structure and positioned along the first axis and opposite to the first magnetic flexible joint assembly;
a middle structure positioned above the support structure and mounted to the first magnetic flexible joint assembly and the second magnetic flexible joint assembly;
a third magnetic flexible joint assembly mounted to the middle structure and positioned along a second axis parallel to the support structure and perpendicular to the first axis;
a fourth magnetic flexible joint assembly mounted to the middle structure and positioned along the second axis and opposite to the third magnetic flexible joint assembly; and
an upper structure positioned above the middle structure and mounted to the third magnetic flexible joint assembly and the fourth magnetic flexible joint assembly,
wherein each magnetic flexible joint assembly comprises:
a ball; and
a joint member, the joint member comprising a depression shaped to accommodate the ball, wherein the ball or the joint member is magnetic,
and further wherein the magnetic flexible joint assemblies are adapted to allow the array to achieve a parallel orientation with respect to the surface upon contact of the array to the surface.

33. The device of claim 32, wherein the magnetic flexible joint assemblies are further adapted to maintain the parallel orientation after contact with the surface is broken.

34. An apparatus comprising a patterning instrument and a device, wherein the device is mounted to the patterning instrument, and further wherein the device comprises:
a support structure adapted to mount an object, the object comprising a plurality of protrusions adapted to form a pattern on a surface of a substrate upon contact of the object to the surface; and
at least one flexible joint assembly mounted to the support structure and adapted to allow the object to achieve a parallel orientation with respect to the surface upon contact of the object to the surface.

35. The apparatus of claim 34, wherein the object is an array of scanning probe tips.

36. The apparatus of claim 34, wherein the patterning instrument is a scanning probe instrument.

37. The apparatus of claim 34, wherein the patterning instrument comprises:
at least one multi-axis assembly comprising at least five nanopositioning stages;
at least one scanning probe tip assembly, wherein the scanning probe tip assembly and the multi-axis assembly are adapted for delivery of material from the scanning probe tip assembly to the substrate, the substrate positioned by the multi-axis assembly;
at least one viewing assembly; and
at least one controller.

38. An apparatus comprising a scanning probe instrument and a device according to claim 13, wherein the device is mounted to the scanning probe instrument.

39. An apparatus comprising a scanning probe instrument and a device according to claim 15, wherein the device is mounted to the scanning probe instrument.

40. An apparatus comprising a scanning probe instrument and a device according to claim 32, wherein the device is mounted to the scanning probe instrument.

41. A method comprising:
providing a device comprising:
a support structure adapted to mount an object, the object comprising a plurality of protrusions adapted to form a pattern on a surface of a substrate upon contact of the object to the surface; and
at least one flexible joint assembly mounted to the support structure and adapted to allow the object to achieve a parallel orientation with respect to the surface upon contact of the object to the surface;
mounting the object to the support structure;
contacting the mounted object to the substrate; and
allowing the object to achieve a parallel orientation with respect to the surface.

42. The method of claim 41, further comprising breaking contact of the object with the surface, wherein the parallel orientation is maintained after contact is broken.

43. The method of claim 41, further comprising providing at least some of the protrusions with an ink composition.

44. The method of claim 41, further comprising providing at least some of the protrusions with an ink composition and transferring the ink composition from the protrusions to the surface.

45. The method of claim 41, wherein the object is an array of scanning probe tips.

46. A method comprising:
providing a device according to claim 13;
mounting the array to the support structure;
contacting the mounted array to the substrate; and
allowing the array to achieve a parallel orientation with respect to the surface.

47. A method comprising:
providing a device according to claim 15;
mounting the array to the support structure;
contacting the mounted array to the substrate; and
allowing the array to achieve a parallel orientation with respect to the surface.

48. A method comprising:
providing a device according to claim 32;
mounting the array to the support structure;
contacting the mounted array to the substrate; and
allowing the array to achieve a parallel orientation with respect to the surface.

49. A method comprising:
providing a device comprising:
a support structure adapted to mount an object, the object comprising a plurality of protrusions adapted to form a pattern on a surface of a substrate upon contact of the object to the surface; and
at least one flexible joint assembly mounted to the support structure and adapted to allow the object to achieve a parallel orientation with respect to the surface upon contact of the object to the surface;
mounting the object to the support structure;
providing at least some of the protrusions with an ink composition; and
transferring the ink composition from the protrusions to the surface.

50. The method of claim 49, wherein the object is an array of scanning probe tips.

51. A method comprising:
providing a device according to claim 13,
mounting the array to the support structure;
providing at least some of the scanning probe tips with an ink composition; and
transferring the ink composition from the scanning probe tips to the surface.

52. A method comprising:
providing a device according to claim 15;
mounting the array to the support structure;
providing at least some of the scanning probe tips with an ink composition; and
transferring the ink composition from the scanning probe tips to the surface.

53. A method comprising:
providing a device according to claim 32;
mounting the array to the support structure;
providing at least some of the scanning probe tips with an ink composition; and
transferring the ink composition from the scanning probe tips to the surface.

54. A mounting fixture adapted to facilitate the mounting of an object to a support structure, the object comprising a plurality of protrusions adapted to form a pattern on a surface of a substrate upon contact of the object to the surface.

55. The mounting fixture of claim 54, wherein the fixture is adapted to facilitate the adhesive mounting of the object to the support structure.

56. The mounting fixture of claim 54, wherein the support structure is adapted to be coupled to a device comprising at least one flexible joint assembly mounted to the support structure and adapted to allow the object to achieve a parallel orientation with respect to the surface upon contact of the object to the surface.

57. The mounting fixture of claim 54, wherein the object is an array of scanning probe tips.

58. The mounting fixture of claim 54, wherein the mounting fixture comprises a cavity adapted to hold the object in a fixed position while leaving a mounting surface on the object exposed during a mounting process.

59. The mounting fixture of claim 54, wherein the mounting fixture comprises a cavity adapted to hold the object in a fixed position while leaving a mounting surface on the object exposed during a mounting process, and further wherein the cavity comprises a lip adapted to support the object along at least a portion of the edge of the object.

60. The mounting fixture of claim 54, wherein the mounting fixture comprises a channel shaped to accommodate a surface of the support structure placed onto a mounting surface on the object.

61. The mounting fixture of claim 54, wherein the mounting fixture comprises a clipping member adapted to hold the support structure in a fixed position atop a mounting surface on the object.

62. The mounting fixture of claim 54, wherein the mounting fixture comprises:
a cavity adapted to hold the object in a fixed position while leaving a mounting surface on the object exposed during a mounting process;
a channel shaped to accommodate a surface of the support structure placed onto a mounting surface on the object; and
a clipping member adapted to hold the support structure in a fixed position atop a mounting surface on the object.

63. A method comprising:
providing the mounting fixture of claim 54; and
mounting the object to the support structure using the mounting fixture.

64. The method of claim 63, further comprising applying an adhesive or glue to a mounting surface on the object.

65. A kit comprising the device of claim 1.

66. A method comprising:
providing a device according to claim 1; wherein the device comprises the support structure, the object, and the at least one flexible joint assembly, and wherein the plurality of protrusions are disposed over a plurality of cantilevers;
contacting a plurality of protrusions to a substrate surface,;
deflecting the plurality of cantilevers;
observing an optical change indicative of surface contact between the plurality of protrusions and the substrate surface; and
further leveling the plurality of protrusions using at least one flexible joint assembly mounted to a support structure.

67. The method of claim 66, wherein the at least one flexible joint assembly is characterized by a coefficient of kinetic friction and a coefficient of static friction, wherein the coefficient of kinetic friction is sufficiently low to allow the plurality of protrusions to move and achieve the parallel orientation upon contact of the plurality of protrusions to the substrate surface, and wherein the coefficient of static friction is sufficiently high to allow the plurality of protrusions to maintain the parallel orientation after contact with the substrate surface is broken.

68. The method of claim 66, wherein the at least one flexible joint assembly comprises
a ball; and
a joint member mounted to the ball, the joint member comprising a depression shaped to accommodate the ball, and
wherein said further leveling comprises rotating the ball in the depression.

69. The method of claim 68, wherein at least one of the ball or the joint member is magnetic.
